(19) United States
(12) Patent Application Publication
(10) Pub. No.: US 2026/0341188 A1
(43) Pub. Date: Oct. 29, 2026

(54) DISPLAY SUBSTRATE AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Ziyang YU, Beijing (CN); Ming HU, Beijing (CN); Zhiliang JIANG, Beijing (CN); Qingqing YAN, Beijing (CN); Quanyong GU, Beijing (CN); Tiaomei ZHANG, Beijing (CN); Wenbo CHEN, Beijing (CN); Tianyi CHENG, Beijing (CN); Jianpeng WU, Beijing (CN); Erjin ZHAO, Beijing (CN); Mengqi WANG, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 18/839,609

(22) PCT Filed: Dec. 25, 2023
(86) PCT No.: PCT/CN2023/141510

§ 371 Date: Aug. 19, 2024

(51) Int. Cl. G09G 3/20

(52) U.S. Cl. CPC G09G 3/20; G09G 2310/0267; G09G 2320/0233

(57) ABSTRACT

Provided are a display substrate and a display device. The display substrate includes: a first gate driving unit and a second gate driving unit each including a buffer unit, the buffer unit includes a first transistor, a second transistor, and an output electrode configured to output a gate control signal; a first electrode of the first transistor and a first electrode of the second transistor are connected to the output electrode; pixel circuits electrically connected to the output electrode of the buffer unit, where the pixel circuits include a pixel group in odd-numbered rows and a pixel group in even-numbered rows; a first gate signal line is connected to the second electrode of the first transistor of the first gate driving unit, and a second gate signal line is connected to the second electrode of the first transistor of the second gate driving unit.

### CROSS REFERENCE TO RELATED APPLICATION(S)

This application is a Section 371 National Stage Application of International Application No. PCT/CN2023/141510 filed on Dec. 25, 2023, the disclosure of which is incorporated herein by reference in its entirety.

### TECHNICAL FIELD

The present disclosure relates to the field of display technology, and in particular to a display substrate and a display device.

### BACKGROUND

At present, gate driving circuits share common gate signal lines used to provide signals to gate electrodes, and output loads of adjacent rows may cause a large noise in a signal on the gate signal line. In a panel with a one-drive-two design for pixels, the noise in a two-row cycle may cause a charging difference between an odd-numbered row of pixels and an even-numbered row of pixels, which may generate a brightness difference between the odd-numbered row and the even-numbered row, thereby causing an uneven display and other display effect problems.

The above information disclosed in this section is just for understanding of the background of technical concept of the present disclosure. Therefore, the above information may include information that does not constitute the related art.

### SUMMARY

In an aspect, a display substrate is provided, including: a gate signal line, including a first gate signal line and a second gate signal line spaced apart from each other, each of the first gate signal line and the second gate signal line is applied with a first voltage; a first gate driving unit a second gate driving unit including a buffer unit, each of the first driving unit and the second driving unit includes a buffer unit, the buffer unit includes a first transistor, a second transistor, and an output electrode configured to output a gate control signal, a first electrode of the first transistor and a first electrode of the second transistor are connected to the output electrode, and a second electrode of the first transistor is connected to the gate signal line; and pixel circuits electrically connected to the output electrode of the buffer unit, the pixel circuits include a pixel group in odd-numbered rows and a pixel group in even-numbered rows, and the pixel group includes at least two rows of pixel circuits. The first gate signal line is connected to the second electrode of the first transistor of the first gate driving unit so that the first gate driving unit provides the gate control signal to the pixel group in odd-numbered rows, and the second gate signal line is connected to the second electrode of the first transistor of the second gate driving unit so that the second gate driving unit provides the gate control signal to the pixel group in even-numbered rows.

In some exemplary embodiments of the present disclosure, the display substrate further includes: a reference gate signal line applied with a second voltage, the reference gate signal line is connected to a second electrode of the second transistor of the buffer unit.

In some exemplary embodiments of the present disclosure, each of the first gate driving unit and the second gate driving unit further includes a scan unit connected to the gate signal line.

In some exemplary embodiments of the present disclosure, the scan unit in the first gate driving unit is electrically connected to the first gate signal line, and the scan unit in the second gate driving unit is electrically connected to the second gate signal line.

In some exemplary embodiments of the present disclosure, the scan unit in the first gate driving unit is electrically connected to the second gate signal line, and the scan unit in the second gate driving unit is electrically connected to the first gate signal line.

In some exemplary embodiments of the present disclosure, the gate signal line further includes a third gate signal line applied with the first voltage, and the third gate signal line is spaced apart from the first gate signal line and the second gate signal line; the third gate signal line is connected to the scan unit in the first gate driving unit; and the third gate signal line is connected to the scan unit in the second gate driving unit.

In some exemplary embodiments of the present disclosure, the reference gate signal line is connected to the scan unit in the first gate driving unit; and the reference gate signal line is connected to the scan unit in the second gate driving unit.

In some exemplary embodiments of the present disclosure, the gate signal line includes: a first connection point where the first gate signal line is connected to the first gate driving unit; a second connection point where the second gate signal line is connected to the second gate driving unit; and/or a third connection point where the third gate signal line is connected to the first gate driving unit or the second gate driving unit; and a short-circuit connection point away from the first connection point, the second connection point and/or the third connection point on the gate signal line, the short-circuit connection point is configured to short-circuit the first gate signal line, the second gate signal line and/or the third gate signal line.

In some exemplary embodiments of the present disclosure, a voltage stabilizing capacitor is provided at a position away from the first connection point, the second connection point and/or the third connection point on the gate signal line, and the voltage stabilizing capacitor is connected to the first gate signal line, the second gate signal line and/or the third gate signal line.

In some exemplary embodiments of the present disclosure, the voltage stabilizing capacitor is provided between the first connection point and the short-circuit connection point, between the second connection point and the short-circuit connection point, and/or between the third connection point and the short-circuit connection point.

In some exemplary embodiments of the present disclosure, the voltage stabilizing capacitor includes: a first voltage stabilizing capacitor connected to the first gate signal line; a second voltage stabilizing capacitor connected to the second gate signal line; and/or a third voltage stabilizing capacitor connected to the third gate signal line.

In some exemplary embodiments of the present disclosure, the short-circuit connection point is located at an edge of a display region of the display substrate; or the short-circuit connection point is located in a flexible printed circuit in the display substrate; or the short-circuit connection point is located in a driver integrated circuit in the display substrate.

In some exemplary embodiments of the present disclosure, the voltage stabilizing capacitor is provided in the flexible printed circuit in the display substrate.

In some exemplary embodiments of the present disclosure, the display substrate includes at least two first gate signal lines and at least two second gate signal lines.

In some exemplary embodiments of the present disclosure, each pixel group in the pixel circuits includes a first row of pixel circuits and a second row of pixel circuits arranged in parallel with the first row of pixel circuits; the first row of pixel circuits and the second row of pixel circuits include a common N-type gate electrode; and the first row of pixel circuits includes a first P-type gate electrode, and the second row of pixel circuits includes a second P-type gate electrode.

In some exemplary embodiments of the present disclosure, the output electrode includes: a first output electrode connected to the N-type gate electrode so as to provide a first gate signal to the N-type gate electrode; a second output electrode connected to the first P-type gate electrode so as to provide a second gate signal to the first P-type gate electrode; and a third output electrode connected to the second P-type gate electrode so as to provide a third gate signal to the second P-type gate electrode.

In some exemplary embodiments of the present disclosure, a low voltage signal in the second gate signal does not overlap with a low voltage signal in the third gate signal in terms of timing sequence.

In some exemplary embodiments of the present disclosure, the display substrate further includes: a first clock signal line, a second clock signal line, an initial signal line, and a control signal line connected to the scan unit.

In some exemplary embodiments of the present disclosure, a timing sequence where a maximum pull-down potential generated by load on the first gate signal line is located does not overlap with a timing sequence where a maximum pull-down potential generated by load on the second gate signal line is located, when the first gate signal line provides the gate control signal to the pixel group in odd-numbered rows and when the second gate signal line provides the gate control signal to the pixel group in even-numbered rows; and a timing sequence where the low voltage signal of the second gate signal is located and a timing sequence where the low voltage signal of the third gate signal is located do not overlap with the timing sequence where the maximum pull-down potential generated by load on the first gate signal line is located and the timing sequence where the maximum pull-down potential generated by load on the second gate signal line is located.

In another aspect of the present disclosure, a display device is provided, including the display substrate described above.

### BRIEF DESCRIPTION OF DRAWINGS

The features and advantages of the present disclosure will be more apparent through the detailed descriptions of exemplary embodiments of the present disclosure with reference to the accompanying drawings. In the accompanying drawings:

FIG. 1A shows a block diagram of a display substrate including GOA in the related art;

FIG. 1B shows a schematic diagram of a gate driving unit in FIG. 1A;

FIG. 2 shows a block diagram of a display substrate according to the embodiments of the present disclosure;

FIG. 3A shows a schematic diagram of a first gate signal line and a second gate signal line being connected to a first gate driving unit and a second driving unit in a display substrate according to an embodiment of the present disclosure;

FIG. 3B shows a schematic diagram of a first gate signal line and a second gate signal line being connected to a first gate driving unit and a second driving unit in a display substrate according to another embodiment of the present disclosure;

FIG. 3C shows a schematic diagram of a first gate signal line, a second gate signal line and a third gate signal line being connected to a first gate driving unit and a second driving unit in a display substrate according to an embodiment of the present disclosure;

FIG. 4A shows a schematic diagram of short-circuiting a first gate signal line and a second gate signal line according to an embodiment of the present disclosure;

FIG. 4B shows a schematic diagram of short-circuiting a first gate signal line and a second gate signal line according to another embodiment of the present disclosure;

FIG. 4C shows a schematic diagram of short-circuiting a first gate signal line and a second gate signal line according to still another embodiment of the present disclosure;

FIG. 4D shows a schematic diagram of short-circuiting a first gate signal line and a second gate signal line according to yet another embodiment of the present disclosure;

FIG. 5A shows a schematic diagram of short-circuiting a first gate signal line, a second gate signal line and a third gate signal line according to an embodiment based on FIG. 3C;

FIG. 5B shows a schematic diagram of short-circuiting a first gate signal line, a second gate signal line and a third gate signal line according to another embodiment based on FIG. 3C;

FIG. 5C shows a schematic diagram of short-circuiting a first gate signal line, a second gate signal line and a third gate signal line according to still another embodiment based on FIG. 3C;

FIG. 5D shows a schematic diagram of short-circuiting a first gate signal line, a second gate signal line and a third gate signal line according to yet another embodiment based on FIG. 3C;

FIG. 6 shows a schematic structural diagram of a voltage stabilizing capacitor according to an embodiment of the present disclosure;

FIG. 7A shows a schematic diagram of short-circuiting a plurality of first gate signal lines and a plurality of second gate signal lines according to an embodiment of the present disclosure;

FIG. 7B shows a schematic diagram of short-circuiting a plurality of first gate signal lines and a plurality of second gate signal lines according to another embodiment of the present disclosure;

FIG. 7C shows a schematic diagram of short-circuiting a plurality of first gate signal lines and a plurality of second gate signal lines according to still another embodiment of the present disclosure;

FIG. 7D shows a schematic diagram of short-circuiting a plurality of first gate signal lines and a plurality of second gate signal lines according to yet another embodiment of the present disclosure;

FIG. 8A shows a signal waveform diagram of a first gate signal line, a second gate signal line, an N-type gate electrode, a first P-type gate electrode and a second P-type gate electrode of a display substrate according to an embodiment of the present disclosure;

FIG. 8B shows a signal waveform diagram of one first gate signal line, one second gate signal line, one N-type gate electrode, one first P-type gate electrode and one second P-type gate electrode according to an embodiment of the present disclosure;

FIG. 9A shows a simulated waveform diagram of a gate control signal on a first signal line and a gate control signal on a second gate signal line in a case that no voltage stabilizing capacitor is provided;

FIG. 9B shows a simulated waveform diagram of a gate control signal on a first signal line and a gate control signal on a second gate signal line in a case that a voltage stabilizing capacitor is provided according to an embodiment of the present disclosure;

FIG. 10A shows a circuit structure diagram of a first gate driving unit according to an embodiment of the present disclosure;

FIG. 10B shows a circuit structure diagram of a first gate driving unit according to an embodiment of the present disclosure;

FIG. 10C shows a circuit structure diagram of a first gate driving unit according to an embodiment of the present disclosure;

FIG. 10D shows a circuit structure diagram of a first gate driving unit according to an embodiment of the present disclosure;

FIG. 10E shows a circuit structure diagram of a first gate driving unit according to an embodiment of the present disclosure;

FIG. 10F shows a circuit structure diagram of a first gate driving unit according to an embodiment of the present disclosure;

FIG. 10G shows a circuit structure diagram of a first gate driving unit according to an embodiment of the present disclosure;

FIG. 10H shows a circuit structure diagram of a first gate driving unit according to an embodiment of the present disclosure; and

FIG. 11 shows a schematic diagram of a display device according to an embodiment of the present disclosure.

### DETAILED DESCRIPTION

In order to make objectives, technical solutions and advantages of the present disclosure clearer, the technical solutions in the embodiments of the present disclosure will be described below clearly and completely with reference to the accompanying drawings. Obviously, the described embodiments are only a part but not all of the embodiments of the present disclosure. Based on the described embodiments of the present disclosure, all additional embodiments obtained by those ordinary skilled in the art without carrying out inventive effort fall within the protection scope of the present disclosure.

It should be noted that in the accompanying drawings, for the purpose of clarity and/or description, a size and relative size of an element may be enlarged. Accordingly, the size and relative size of each element need not to be limited to those shown in the accompanying drawings. In the specification and the accompanying drawings, the same or similar reference numerals indicate the same or similar components.

When an element is described as being “on”, “connected to” or “coupled to” another element, the element may be directly on the another element, directly connected to the another element, or directly coupled to the another element, or an intermediate element may be provided. However, when an element is described as being “directly on”, “directly connected to” or “directly coupled to” another element, no intermediate element is provided. Other terms and/or expressions used to describe a relationship between elements, such as “between” and “directly between”, “adjacent to” and “directly adjacent to”, “on” and “directly on”, and so on, should be interpreted in a similar manner. Moreover, the term “connection” may refer to a physical connection, an electrical connection, a communicative connection, and/or a fluid connection. In addition, X-axis, Y-axis and Z-axis are not limited to three axes of a rectangular coordinate system, and may be interpreted in a broader meaning. For example, the X-axis, the Y-axis and the Z-axis may be perpendicular to each other, or may represent different directions that are not perpendicular to each other. For the purpose of the present disclosure, “at least one selected from X, Y or Z” and “at least one selected from a group consisting of X, Y and Z” may be interpreted as only X, only Y, only Z, or any combination of two or more of X, Y and Z, such as XYZ, XYY, YZ and ZZ. As used herein, the term “and/or” includes any and all combinations of one or more of the listed related items.

It should be noted that although the terms “first”, “second”, and so on may be used here to describe various components, members, elements, regions, layers and/or portions, these components, members, elements, regions, layers and/or portions should not be limited by these terms. Rather, these terms are used to distinguish one component, member, element, region, layer and/or portion from another one. Thus, for example, a first component, a first member, a first element, a first region, a first layer and/or a first portion discussed below may be referred to as a second component, a second member, a second element, a second region, a second layer and/or a second portion without departing from teachings of the present disclosure.

For ease of description, spatial relationship terms, such as “upper”, “lower”, “left”, “right”, may be used here to describe a relationship between an element or feature and another element or feature as shown in the drawings. It should be understood that the spatial relationship terms are intended to cover other different orientations of a device in use or operation in addition to the orientation described in the drawings. For example, if a device in the drawings is turned upside down, an element or feature described as “below” or “under” another element or feature will be oriented “above” or “on” the another element or feature.

It should be noted that the expression “the same layer” herein refers to a layer structure that is formed by firstly forming, using a same film forming process, a film layer used to form a specific pattern, and then patterning, using one-time patterning process, the film layer with a same mask. Depending on different specific patterns, the one-time patterning process may include a plurality of exposure, development or etching processes, and the specific pattern in the formed layer structure may be continuous or discontinuous. That is, a plurality of elements, components, structures and/or portions located in the “same layer” are made of the same material and formed by the same patterning process. Generally, a plurality of elements, components, structures and/or portions located in the “same layer” have substantially the same thickness.

Those skilled in the art should understand that, unless otherwise specified, the expression “height” or “thickness” herein refers to a size in a direction perpendicular to a surface of each film layer provided on the display substrate, that is, a size in a light emitting direction of the display substrate, or called a size in a normal direction of the display device.

Herein, directional expressions “first direction” and “second direction” are used to describe different directions in a pixel region, such as a longitudinal direction and a lateral direction in the pixel region, or a row direction and a column direction in which sub-pixels are arranged. It should be understood that such expressions are just exemplary descriptions and not limitations to the present disclosure.

Transistors used in the embodiments of the present disclosure may be thin film transistors, or field effect transistors, or other devices having same characteristics. Since a source electrode and a drain electrode of a thin film transistor used here are symmetrical, the source electrode and the drain electrode may be interchanged. In the embodiments of the present disclosure, a transistor may include a gate electrode, a first electrode and a second electrode, the first electrode may represent one of the source electrode and the drain electrode, and the second electrode may represent the other of the source electrode and the drain electrode. In the following examples, a P-type thin film transistor being used as a driving transistor is mainly described, and other transistors may have a type same as or different from the driving transistor according to a circuit design. Similarly, in other embodiments, the driving transistor may also be shown as an N-type thin film transistor.

Some exemplary embodiments of the present disclosure provide a display substrate, including: a gate signal line, including a first gate signal line and a second gate signal line spaced apart from each other, where each of the first gate signal line and the second gate signal line is applied with a first voltage; a first gate driving unit including a buffer unit and a second gate driving unit including a buffer unit, where the buffer unit includes a first transistor, a second transistor, and an output electrode configured to output a gate control signal, a first electrode of the first transistor and a first electrode of the second transistor are connected to the output electrode, and a second electrode of the first transistor is connected to the gate signal line; and pixel circuits electrically connected to the output electrode of the buffer unit, where the pixel circuits include a pixel group in odd-numbered rows and a pixel group in even-numbered rows, and the pixel group includes at least two rows of pixel circuits, the first gate signal line is connected to the second electrode of the first transistor of the first gate driving unit so that the first gate driving unit provides the gate control signal to the pixel group in odd-numbered rows, and the second gate signal line is connected to the second electrode of the first transistor of the second gate driving unit so that the second gate driving unit provides the gate control signal to the pixel group in even-numbered rows.

In the embodiments of the present disclosure, by providing the gate signal line as the first gate signal line connected to the first gate driving unit and the second gate signal line connected to the second gate driving unit, the first gate signal line may provide the gate control signal to the pixel group in odd-numbered rows, and the second gate signal line may provide the gate control signal to the pixel group in even-numbered rows, that is, a segmented control of the gate control signal is achieved, so that a problem that a noise is generated by a load on the gate signal line and affects pixel circuits so as to cause an uneven display of two rows of pixel circuits in a pixel group may be effectively avoided, and a display effect of the display substrate may be effectively improved.

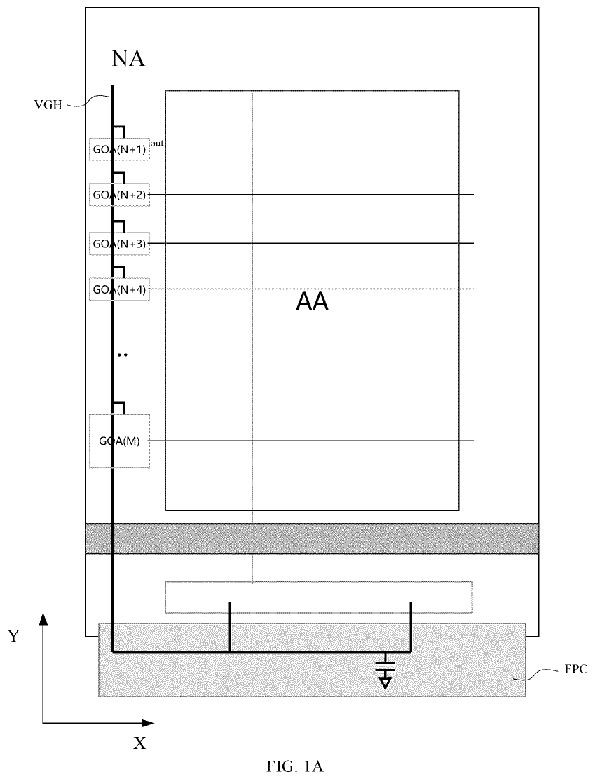

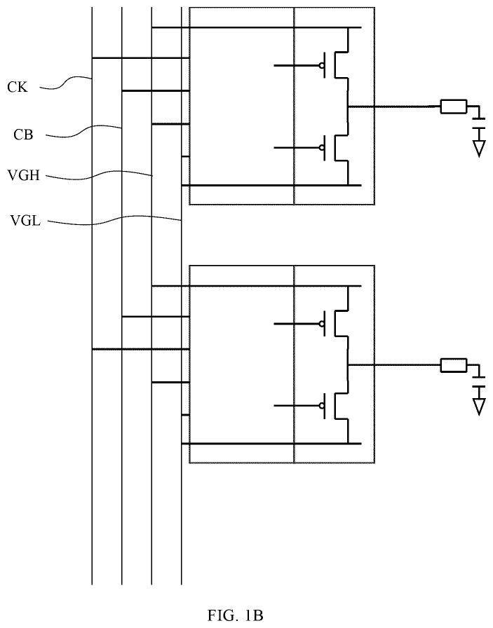

FIG. 1A shows a block diagram of a display substrate including GOA in the related art. FIG. 1B shows a schematic diagram of a gate driving unit in FIG. 1A.

As shown in FIG. 1A, an existing display substrate includes a display region AA located on the display substrate, and a non-display region NA at an edge of the display region AA. A gate signal line is arranged to provide a signal to a gate driving circuit (e.g., GOA) that controls each row of pixels, so that the gate driving circuit may control a gate electrode of a pixel circuit located in the display region AA through a signal output from an out terminal (out), thereby controlling pixel lighting, turning off and brightness.

As shown in FIG. 1A and FIG. 1B, in existing designs, each row of pixels in the display substrate is provided with a signal through a gate driving circuit. In the display substrate, a gate signal line (VGH) and a reference gate signal line (VGL) are shared by different rows of pixels. A section of the gate signal line and a section of the reference gate signal line are uniformly connected to a flexible printed circuit (FPC), and finally connected to an output terminal of an integrated circuit (such as DDIC (Display Driver IC) or PMIC (Power Management Integrated Circuit), etc.) through FPC wires.

As shown in FIG. 1B, each row of gate driving circuits further includes a plurality of clock signal lines, such as a first clock signal line CK and a second clock signal line CB, and a reference gate signal line VGL. The clock signal line CK, the gate signal line VGH and the reference gate signal line VGL are shared, and the gate signal lines VGH for different rows of pixels are connected to a same gate signal line. When charging a gate wire in a pixel circuit using the gate signal line, the gate signal line VGH firstly charges the gate wire through a transistor at a pull-up node. Due to a large instantaneous current, there is a load (for example, a resistive load) on the gate signal line. In this case, a voltage of the gate signal line VGH is pulled down to generate a pull-down potential, and then returns to a set pull-up voltage. In this process, the voltage on the gate signal line VGH presents a fluctuating noise, and the noise is finally transmitted to a gate wire in a non-pull-down state in the pixel circuit and results in a noise on that gate wire, which in turn affects a luminous state of a pixel unit in the pixel circuit and causes a problem of local brightness change.

When a common N-type gate electrode is used in the pixel circuit to drive P-type gate electrodes in two rows of pixels, turning on a P-type gate electrode in an odd-numbered row of pixels and turning on a P-type gate electrode in an even-numbered row of pixels correspond to different noise states of N-type gate signal, which may cause a difference between a gate signal in the odd-numbered row and a gate signal in the even-numbered row and finally form a horizontal stripe mura caused by uneven brightness in the odd-numbered row and the even-numbered row, thus reducing the display effect of the display substrate.

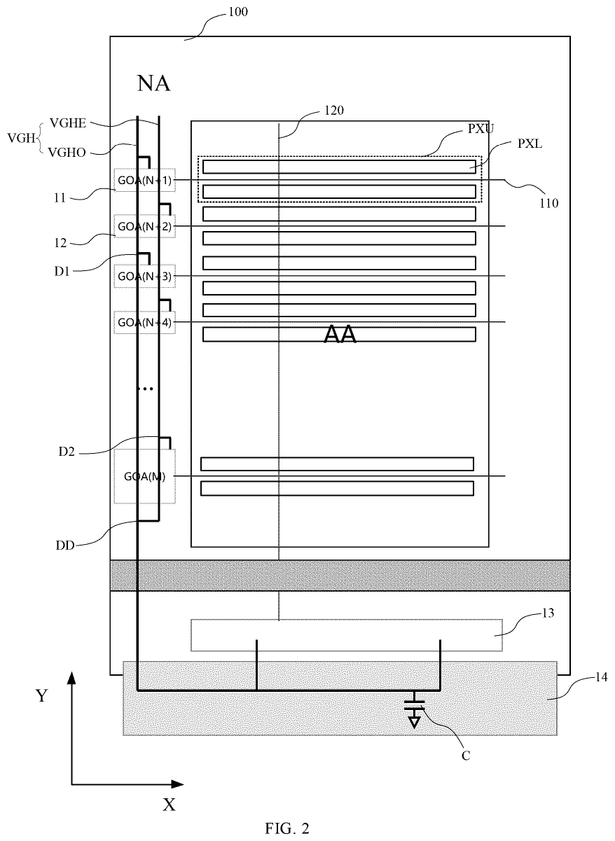

In order to solve the above problem, the present disclosure provides a display substrate. A structure of the display substrate according to the embodiments of the present disclosure will be described below with reference to FIG. 2 to FIG. 10H.

FIG. 2 shows a block diagram of a display substrate according to the embodiments of the present disclosure.

With reference to FIG. 2, a display substrate 100 according to the embodiments of the present disclosure may include a base substrate and pixel units provided on the base substrate. The pixel units are arranged along rows and columns, for example, in a first direction X and a second direction Y, so as to form a pixel region.

The display substrate may include a display region AA and a non-display region NA. The display region AA may be a region in which the pixel units for displaying images are provided, and each pixel unit will be described later. The non-display region NA is a region in which no pixel unit is provided, that is, a region in which no image is displayed. The non-display region NA corresponds to a bezel in a final display device, and a width of the bezel may be determined according to a width of the non-display region NA.

The display region AA may have various shapes. For example, the display region AA may be provided in various shapes such as a closed polygon including straight sides (e.g., a rectangle), a circle or an ellipse, etc. including a curved side, and a semicircle or a semi-ellipse, etc. including a straight side and a curved side. In the embodiments of the present disclosure, the display region AA is provided as a region having a quadrangular shape including straight sides. It should be understood that this is just an exemplary embodiment of the present disclosure, rather than a limitation to the present disclosure.

The non-display region NA may be arranged on at least one side of the display region AA. In the embodiments of the present disclosure, the non-display region NA may surround a periphery of the display region AA. In the embodiments of the present disclosure, the non-display region NA may include a lateral portion extending in the first direction X and a longitudinal portion extending in the second direction Y.

The pixel units are arranged in the display region AA. A pixel unit is a minimum unit for displaying image, and a plurality of pixel units may be provided. For example, the pixel unit may include light emitting devices that emit white light and/or color light.

A plurality of pixel units may be provided in a form of a matrix along rows extending in the first direction X and columns extending in the first direction Y. However, the embodiments of the present disclosure do not specifically limit an arrangement form of the pixel units, and the pixel units may be arranged in various forms. For example, the pixel units may be arranged such that a direction inclined with respect to the first direction X and the first direction Y is a column direction, and a direction intersecting the column direction is a row direction.

That is, a plurality of pixel units are arranged in an array in the first direction X and the second direction Y so as to form a plurality of rows of pixel units and a plurality of columns of pixel units.

A pixel unit may include a plurality of sub-pixels. For example, a pixel unit may include three sub-pixels, namely a first sub-pixel, a second sub-pixel, and a third sub-pixel. For example, the first sub-pixel may be a red sub-pixel, the second sub-pixel may be a green sub-pixel, and the third sub-pixel may be a blue sub-pixel.

It should be noted that in the embodiments of the present disclosure, the number of sub-pixels included in a pixel unit is not particularly restricted, and is not limited to three as described above.

Each pixel unit is arranged along a set row to form a row of pixels PXL, and each pixel unit has a pixel circuit for controlling turn-on, turn-off and brightness of each pixel. A control of a pixel may be achieved by a data line to be described below and the gate signal line described above. The pixel circuit includes an N-type gate electrode and a P-type gate electrode.

In the embodiment, two rows of pixels PXL together form a group. For example, a first row of pixels PXL and a second row of pixels PXL form a group, that is, a pixel group PXU. Each pixel group includes a first row of pixel circuits corresponding to the first row of pixels PXL and a second row of pixel circuits corresponding to the second row of pixels PXL, and the first row of pixel circuits and the second row of pixel circuits are arranged in parallel.

In some embodiments of the present disclosure, in two adjacent rows of pixels PXL arranged in parallel, the first row of pixel circuits and the second row of pixel circuits include a common N-type gate electrode. Each row of pixel circuits further includes a P-type gate electrode. For example, the first row of pixel circuits includes a first P-type gate electrode, and the second row of pixel circuits includes a second P-type gate electrode.

For example, in an exemplary embodiment shown in FIG. 2, a scanning control signal line 110 and a data line 120 are schematically shown. That is, the display substrate 100 may further include a plurality of scanning control signal lines 110 and a plurality of data lines 120 on the base substrate. The plurality of scanning control signal lines 110 may provide scanning control signals, that is, gate control signals output by the output electrode of the first gate driving unit and the output electrode of the second gate driving unit, to the plurality of rows of pixel units respectively, and the plurality of data lines 120 may provide data signals to the plurality of columns of pixel units respectively. The scanning control signal line 110 extends in the first direction X, and the plurality of scanning control signal lines 110 are arranged at intervals in the second direction Y. The data line 120 extends in the second direction Y, and the plurality of data lines 120 are arranged at intervals in the first direction X.

For example, the scanning control signal line 110 may be a representative of lateral wires, and the data line 120 may be a representative of longitudinal wires. It should be understood that the lateral wires may further include wires of other types or wires for providing other signals, and the longitudinal wires may further include wires of other types or wires for providing other signals.

Each sub-pixel may include a light emitting element and a pixel driving circuit for driving the light emitting element. For example, in an OLED display substrate or display panel, the light emitting element of the sub-pixel may include an anode, a luminescent material layer and a cathode arranged in a stack. The anodes of the light emitting elements of the sub-pixels are arranged at intervals in a matrix form along rows extending in the first direction X and columns extending in the first direction Y.

It should be noted that the transistors in the pixel circuits may be divided into N-type transistors and P-type transistors depending on semiconductor characteristics of transistors. When a transistor is used as a switching transistor, an N-type switching transistor is turned on under a control of a high-level switching control signal and turned off under a control of a low-level switching control signal; and a P-type switching transistor is turned on under a control of a low-level switching control signal and turned off under a control of a high-level switching control signal.

In the embodiments of the present disclosure, the pixel circuit may be an LTPO circuit, which is prepared by a low temperature poly silicon (LTPS) technology and an oxide (e.g., IGZO). In a LTPS (low temperature poly silicon) thin-film transistor, an active layer is formed by a poly silicon deposition. LTPS has advantages of a high electron mobility, a fast response speed, and advantages of high brightness, high resolution and low power consumption. In an oxide TFT (oxide thin-film transistor), for example, an oxide semiconductor such as IGZO (indium gallium zinc oxide) may be used as an active layer of the TFT. The oxide semiconductor has a high electron mobility and a good turn-off characteristic. Compared with LTPS, the oxide semiconductor has a simple manufacturing process and has a high compatibility with amorphous silicon processes. Certainly, the oxide thin-film transistor may also be other metal oxide semiconductors, such as IZTO (indium zinc tin oxide) or IGZTO (indium gallium zinc tin oxide), etc. The use of the oxide thin-film transistor may effectively reduce a size of the transistor and prevent a current leakage, so that the pixel circuit may be applied to low-frequency driving and a resolution of the display substrate may be increased.

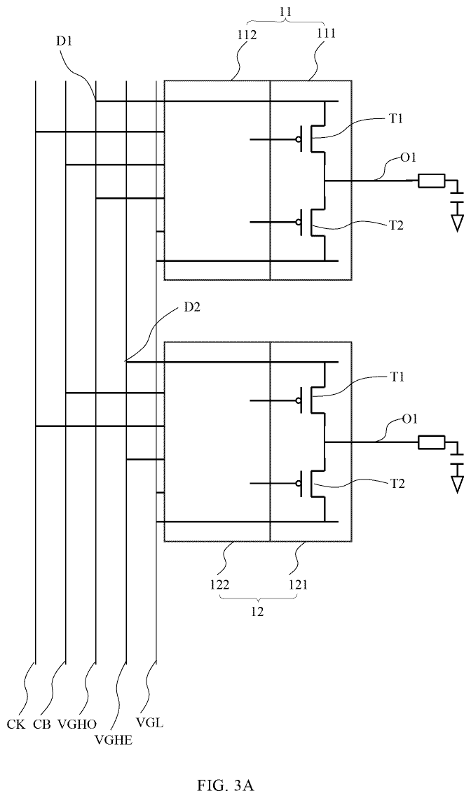

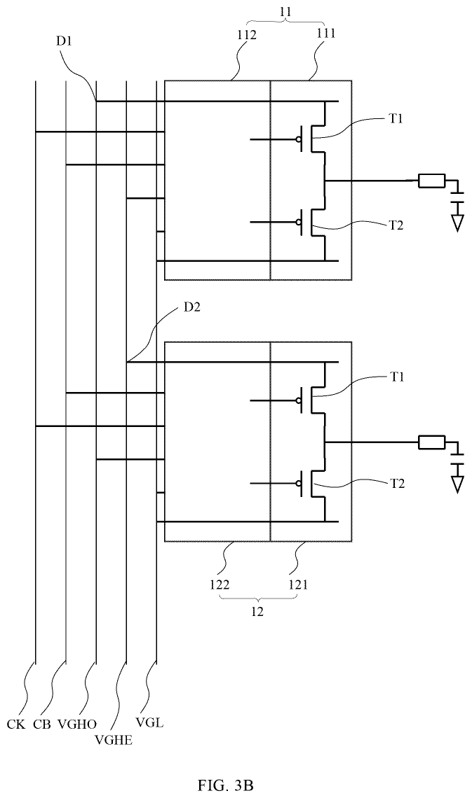

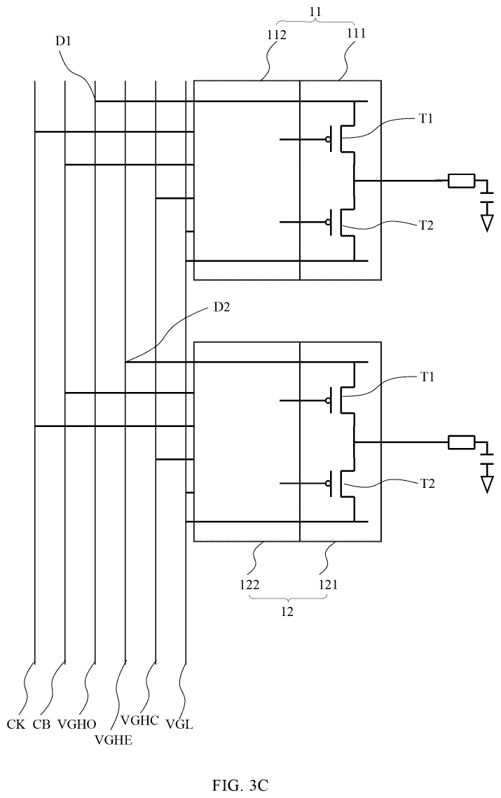

FIG. 3A shows a schematic diagram of a first gate signal line and a second gate signal line being connected to a first gate driving unit and a second driving unit in a display substrate according to an embodiment of the present disclosure. FIG. 3B shows a schematic diagram of a first gate signal line and a second gate signal line being connected to a first gate driving unit and a second driving unit in a display substrate according to another embodiment of the present disclosure. FIG. 3C shows a schematic diagram of a first gate signal line, a second gate signal line and a third gate signal line being connected to a first gate driving unit and a second driving unit in a display substrate according to an embodiment of the present disclosure.

The structure of the display substrate according to the embodiments of the present disclosure will be described below with reference to FIG. 2 and FIG. 3A to FIG. 3C.

The display substrate 100 includes a gate signal line VGH, a reference gate signal line VGL, a first clock signal line CK, and a second clock signal line CB.

The gate signal line VGH includes a first gate signal line VGHO and a second gate signal line VGHE. Each of the first gate signal line VGHO and the second gate signal line VGHE is applied with a first voltage V1. The first gate signal line VGHO and the second gate signal line VGHE are spaced apart from each other. For example, the first gate signal line VGHO and the second gate signal line VGHE extend in the second direction Y and are located on a side of the display substrate close to the display region AA. The first gate signal line VGHO is spaced by a certain distance from the second gate signal line VGHE so that the first gate signal line VGHO and the second gate signal line VGHE are spaced apart.

The same as the gate signal line VGH, the reference gate signal line VGL is provided on a side of the display substrate close to the display region AA and located in the non-display region NA. The reference gate signal line VGL also extends in the second direction Y and is spaced apart from the gate signal line VGH to avoid mutual influence between signals. The reference gate signal line VGL is applied with a second voltage V2.

The display substrate 100 is provided with a first gate driving unit 11 and a second gate driving unit 12, each including a scan unit and a buffer unit. The first gate driving unit 11 and the second gate driving unit 12 may have completely the same structure. For example, the first gate driving unit 11 includes a buffer unit 111 and a scan unit 112, and the second gate driving unit 12 includes a buffer unit 121 and a scan unit 122.

In some optional embodiments, the first gate driving unit 11 and/or the second gate driving unit 12 may include one or more gate driving circuits GOAs. For example, in the embodiment, the first gate driving unit 11 and the second gate driving unit 12 have the same structure, each including a gate driving circuit GOA.

The buffer unit 111 includes a first transistor T1, a second transistor T2, and an output electrode O1 configured to output a gate control signal. A gate electrode of the first transistor T1 is connected to a pull-up node, and a gate electrode of the second transistor T2 is connected to a pull-down node. A first electrode of the first transistor T1 and a first electrode of the second transistor T2 are connected to the output electrode O1. A second electrode of the first transistor T1 is connected to the gate signal line VGH. A second electrode of the second transistor T2 of the buffer unit 111 is connected to the reference gate signal line VGL.

The display substrate is further provided with a pixel circuit which includes a third transistor and a fourth transistor. The third transistor is an N-type transistor, which is shared by, for example, a first row of pixel circuits and a second row of pixel circuits in a pixel group. A gate electrode of the third transistor is connected to the output electrode of the buffer unit.

The pixel circuits include a pixel group PXU in odd-numbered rows and a pixel group PXU in even-numbered rows. For example, the pixel group PXU in odd-numbered rows and the pixel group PXU in even-numbered rows each include two rows of pixel circuits PXL.

In other optional embodiments, the pixel group PXU may include more rows of pixel circuits.

The first gate signal line VGHO is connected to the second electrode of the first transistor T1 of the first gate driving unit 11, so that the first gate driving unit 11 provides the gate control signal to the pixel group in odd-numbered rows. The second gate signal line VGHE is connected to the second electrode of the first transistor T1 of the second gate driving unit 12, so that the second gate driving unit 12 provides the gate control signal to the pixel group in even-numbered rows.

In the embodiments of the present disclosure, the first gate signal line VGHO and the second gate signal line VGHE are spaced apart and provide gate control signals respectively to the pixel group in odd-numbered rows and the pixel group in even-numbered rows, so that a problem of a fluctuation interference between an odd-numbered row and an even-numbered row caused by loads on the first gate signal line VGHO and the second gate signal line VGHE may be effectively avoided, and the gate control signals for two rows of pixel circuits in a pixel group may be protected from being interfered by the noise on the first gate signal line or the second gate signal line.

In some embodiments, the scan unit is connected to the gate signal line.

In an embodiment, as shown in FIG. 3A, the buffer unit 111 in the first gate driving unit 11 is connected to the first gate signal line VGHO. Specifically, the first gate signal line VGH is connected to the second electrode of the first transistor T1 of the first gate driving unit 11, and the scan unit 112 in the first gate driving unit 11 is electrically connected to the first gate signal line VGHO. The buffer unit 121 in the second gate driving unit 12 is connected to the second gate signal line VGHE. Specifically, the second gate signal line VGHE is connected to the second electrode of the first transistor T2 of the second gate driving unit 12, and the scan unit 112 in the second gate driving unit 12 is electrically connected to the second gate signal line VGHE. The reference gate signal line VGL is connected to the scan unit 112 in the first gate driving unit 11 and to the second electrode of the second transistor T2 of the buffer unit 111 in the first gate driving unit 11. Similarly, the reference gate signal line VGL is connected to the scan unit 122 in the second gate driving unit 12 and to the second electrode of the second transistor T2 of the buffer unit 121 in the second gate driving unit 12.

In another embodiment, as shown in FIG. 3B, the buffer unit 111 in the first gate driving unit 11 is connected to the first gate signal line VGHO. Specifically, the first gate signal line VGHO is connected to the second electrode of the first transistor T of the first gate driving unit 11, and the scan unit 112 in the first gate driving unit 11 is electrically connected to the second gate signal line VGHE. The buffer unit 121 in the second gate driving unit 12 is connected to the second gate signal line VGHE. Specifically, the second gate signal line VGHE is connected to the second electrode of the first transistor T1 of the second gate driving unit 12, and the scan unit 122 in the second gate driving unit 12 is electrically connected to the first gate signal line VGHO.

In another embodiment, as shown in FIG. 3C, the gate signal line VGH further includes a third gate signal line VGHC, which is applied with the first voltage V1. The third gate signal line VGHC is spaced apart from the first gate signal line VGHO and the second gate signal line VGHE.

The first gate signal line VGHO is connected to the second electrode of the first transistor T1 of the buffer unit 111 in the first gate driving unit 11, the second gate signal line VGHE is connected to the second electrode of the first transistor T1 of the buffer unit 121 in the second gate driving unit 12, and the third gate signal line VGHC is connected to the scan unit 112 in the first gate driving unit 11 and to the scan unit 122 in the second gate driving unit 12.

In some embodiments of the present disclosure, the gate signal line VGH includes: a first connection point DI where the first gate signal line VGHO is connected to the first gate driving unit 11; a second connection point D2 where the second gate signal line VGHE is connected to the second gate driving unit 12; and/or a third connection point D3 where the third gate signal line VGHC is connected to the first gate driving unit 11 or the second gate driving unit 12; and a short-circuit connection point DD away from the first connection point DI, the second connection point D2 and/or the third connection point D3 on the gate signal line, where the short-circuit connection point is configured to short-circuit the first gate signal line VGHO, the second gate signal line VGHE and/or the third gate signal line VGHC.

Exemplarily, the first connection point DI is a point where, for example, the first gate signal line extending in the second direction Y is connected to the second electrode of the first transistor of the buffer unit in the first gate driving unit. The second connection point D2 is a point where, for example, the second gate signal line extending in the second direction Y is connected to the second electrode of the first transistor of the buffer unit in the second gate driving unit. The third connection point D3 is a point where, for example, the third gate signal line extending in the second direction Y is connected to the scan unit of the first gate driving unit or the scan unit of the second gate driving unit.

For example, when a last row in the pixel group is an odd-numbered row, the third connection point D3 is a point where the third gate signal line is connected to the scan unit of the first gate driving unit; and when the last row in the pixel group is an even-numbered row, the third connection point D3 is a point where the third gate signal line is connected to the scan unit of the second gate driving unit.

When the gate signal line includes the first gate signal line and the second gate signal line, the short-circuit connection point DD is a point that short-circuits the first gate signal line and the second gate signal line. When the gate signal line includes the first gate signal line, the second gate signal line and the third gate signal line, the short-circuit connection point is a point that short-circuits the first gate signal line, the second gate signal line and the third gate signal line.

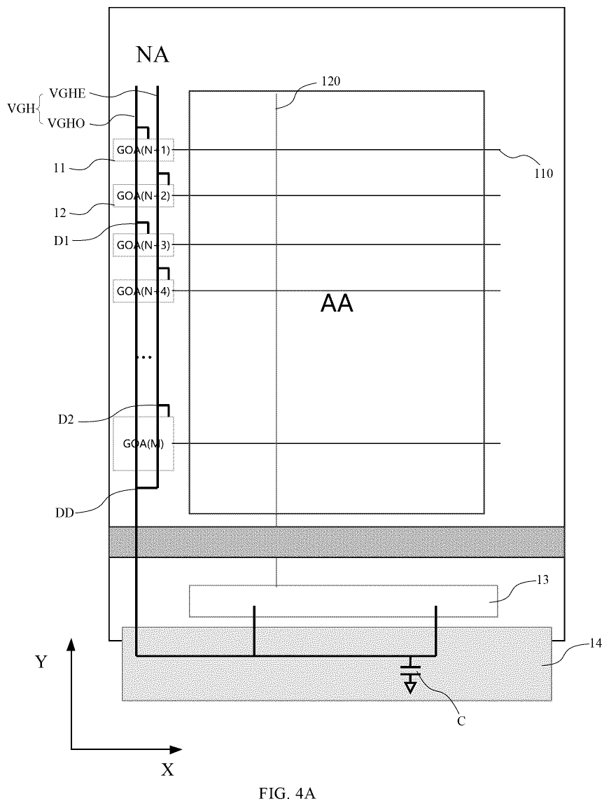

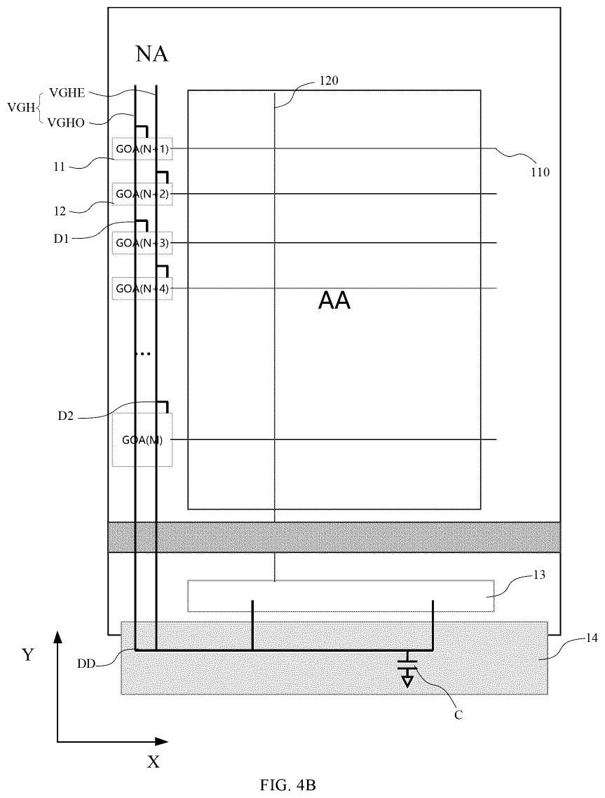

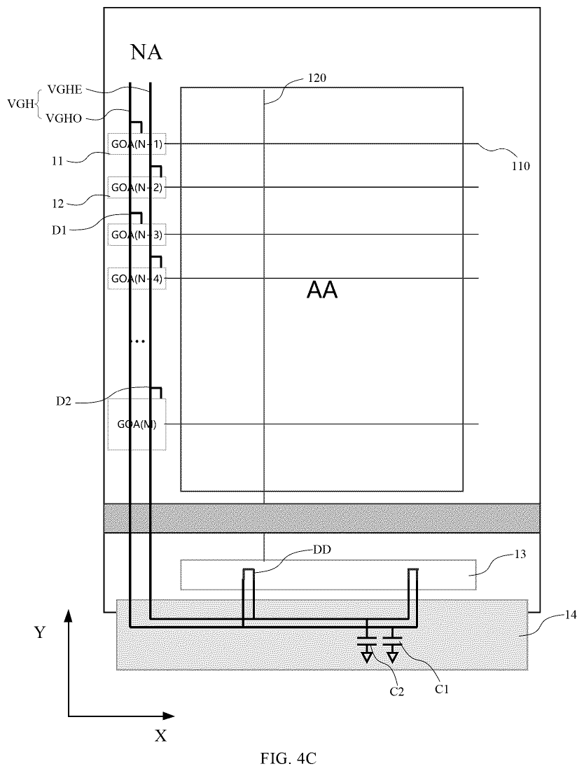

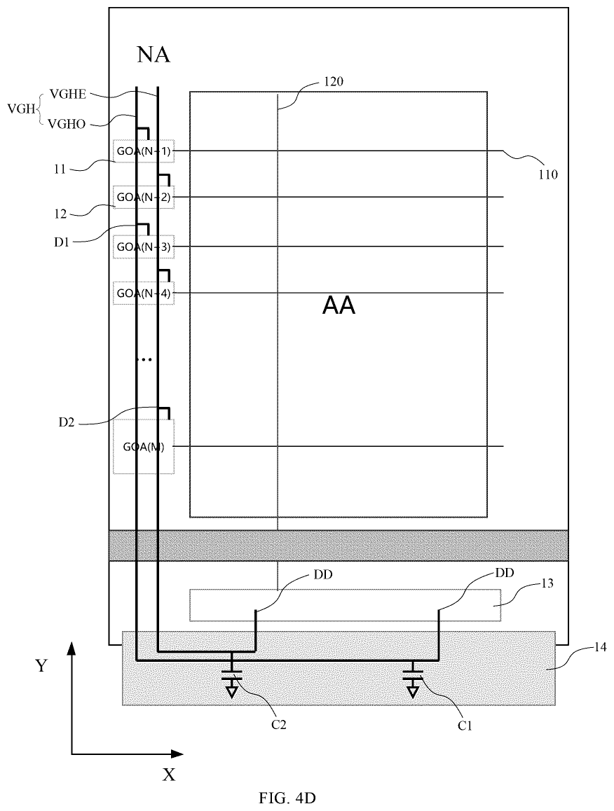

The first connection point, the second connection point and the short-circuit connection point on the first gate signal line and the second gate signal line will be described below with reference to FIG. 4A to FIG. 4D.

FIG. 4A shows a schematic diagram of short-circuiting the first gate signal line and the second gate signal line according to an embodiment of the present disclosure. FIG. 4B shows a schematic diagram of short-circuiting the first gate signal line and the second gate signal line according to another embodiment of the present disclosure. FIG. 4C shows a schematic diagram of short-circuiting the first gate signal line and the second gate signal line according to still another embodiment of the present disclosure. FIG. 4D shows a schematic diagram of short-circuiting the first gate signal line and the second gate signal line according to yet another embodiment of the present disclosure

In the embodiments shown in FIG. 4A to FIG. 4D, one first gate signal line VGHO and one second gate signal line VGHE are provided. The first gate signal line VGHO is used to allow the first gate driving unit 11 to provide a gate control signal to a pixel group in odd-numbered rows, and the second gate signal line VGHE is used to allow the second gate driving unit 12 to provide a gate control signal to a pixel group in even-numbered rows.

In order to reduce a mutual interference of voltage fluctuation caused by a load during a power-on process of the first gate signal line and the second gate signal line, a short-circuit connection point is provided away from the first connection point and the second connection point on the gate signal line so as to short-circuit the first gate signal line and the second gate signal line.

The first connection point is connected to the second electrode of the first transistor of the buffer unit in the first gate driving unit, the second connection point is connected to the second electrode of the first transistor of the buffer unit in the second gate driving unit, and a noise interference may occur between the gate signal lines for different rows in a case of pulling up. If the short-circuit connection point for short-circuiting the first gate signal line and the second gate signal line is provided at a position close to the first connection point or the second connection point, there may be a problem of mutual interference of electrical signals on the first gate signal line and the second gate signal line. Therefore, the short-circuit connection point is provided at a position away from the first connection point and the second connection point on the gate signal line, so that a problem of mutual interference of electrical signals on the gate signal lines may be effectively reduced or completely avoided.

A voltage stabilizing capacitor C is provided at a position away from the first connection point D1 and the second connection point D2 on the gate signal line VGH, and the voltage stabilizing capacitor C is connected to the first gate signal line VGHO and the second gate signal line VGHE. The voltage stabilizing capacitor C is provided between the first connection point D1 and the short-circuit connection point DD and between the second connection point D2 and the short-circuit connection point DD.

In order to further reduce a jitter of the electrical signals generated by the loads on the first gate signal line and the second gate signal line during the pull-up process, the voltage stabilizing capacitor is provided at one end of the first gate signal line and the second gate signal line, thereby reducing the noise on the first gate signal line and the second gate signal line and suppressing the jitter.

The voltage stabilizing capacitor C includes a first voltage stabilizing capacitor C1 connected to the first gate signal line VGHO and a second voltage stabilizing capacitor C2 connected to the second gate signal line VGHE. The voltage stabilizing capacitor is arranged in a flexible printed circuit 14 of the display substrate.

In some embodiments of the present disclosure, each gate signal line is provided with a voltage stabilizing capacitor. In a case of signal jitter on different gate signal lines, the voltage stabilizing capacitor may reduce the noise on the gate signal line and suppress the jitter. Meanwhile, since each gate signal line is provided with the voltage stabilizing capacitor, it is possible to avoid a problem of mutual interference of the gate signal lines through the short-circuit connection point, and further improve a signal stability on each gate signal line of the entire display substrate.

As shown in FIG. 4A, the short-circuit connection point is located at an edge of the display region of the display substrate, that is, the short-circuit connection point is provided in the non-display region NA and located at an edge of the display region AA. As shown in FIG. 4B, the short-circuit connection point is located in the flexible printed circuit 14 of the display substrate. As shown in FIG. 4C and FIG. 4D, the short-circuit connection point is located in a driver integrated circuit 13 of the display substrate. As shown in FIG. 4C, the first gate signal line VGHO and the second gate signal line VGHE are respectively pulled onto adjacent pins in the driver integrated circuit 13 and short-circuited in the driver integrated circuit. As shown in FIG. 4D, the first gate signal line VGHO and the second gate signal line VGHE are respectively pulled onto different pins on two sides of the driver integrated circuit 13 and short-circuited in the driver integrated circuit.

Furthermore, each of the first gate signal line VGHO and the second gate signal line VGHE is provided with the voltage stabilizing capacitor, such as the first voltage stabilizing capacitor C1 and the second voltage stabilizing capacitor C2. The first voltage stabilizing capacitor C1 and the second voltage stabilizing capacitor C2 are provided in the flexible printed circuit 14 so as to suppress the noise of signal on each gate signal line and improve the display effect of the display substrate.

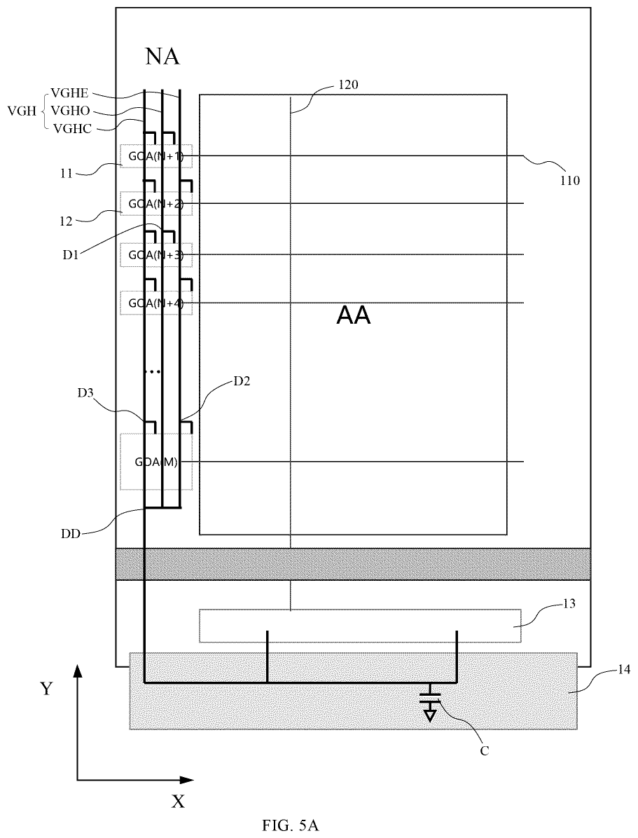

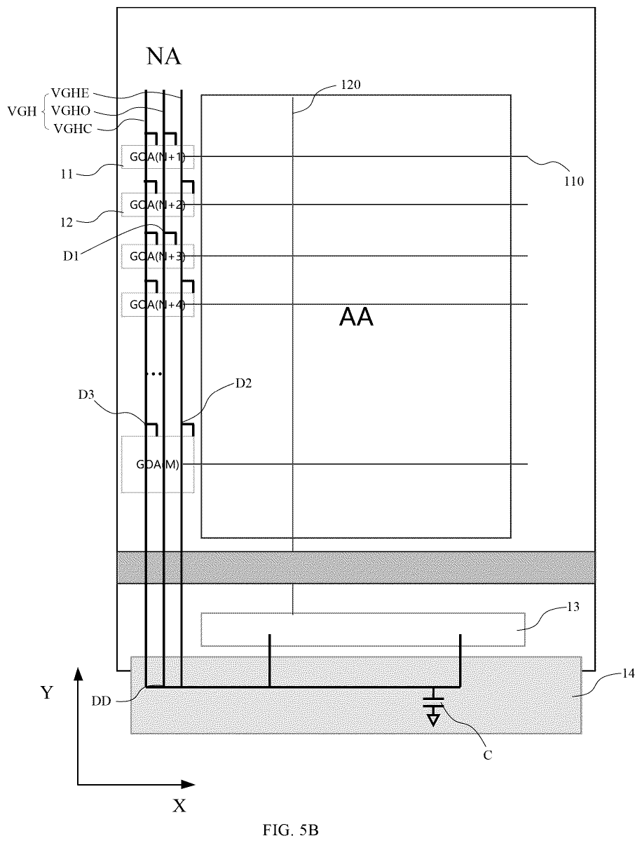

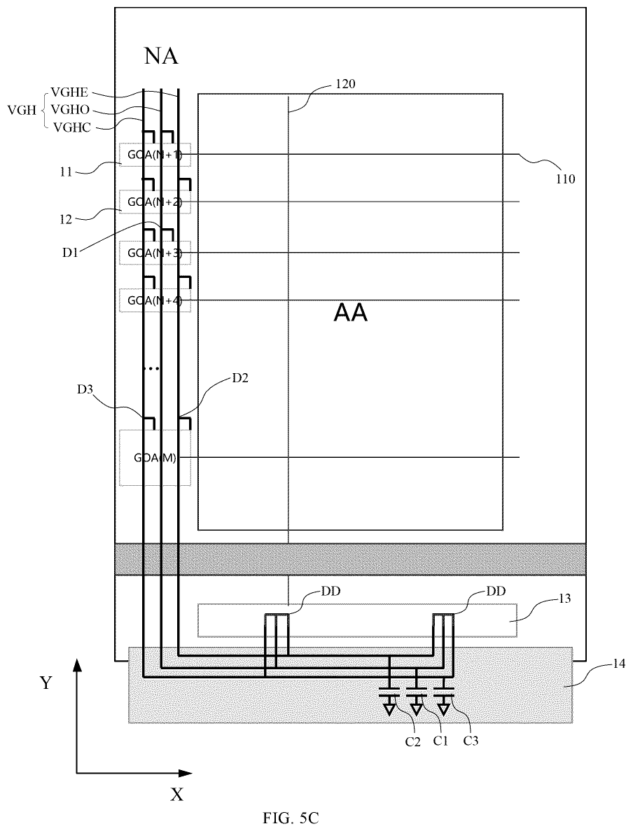

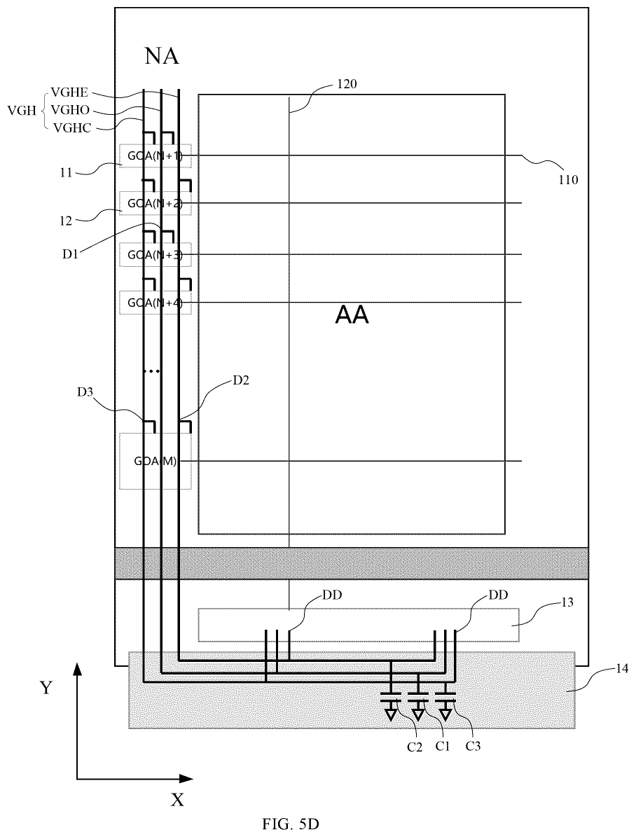

In some embodiments of the present disclosure, the gate signal line VGH further includes a third gate signal line VGHC. The first connection point D1, the second connection point D2, the third connection point D3 and the short-circuit connection point DD on the first gate signal line VGHO, the second gate signal line VGHE and the third gate signal line VGHC in the embodiments of the present disclosure will be described below with reference to FIG. 5A to FIG. 5D.

FIG. 5A shows a schematic diagram of short-circuiting the first gate signal line, the second gate signal line and the third gate signal line according to an embodiment based on FIG. 3C. FIG. 5B shows a schematic diagram of short-circuiting the first gate signal line, the second gate signal line and the third gate signal line according to another embodiment based on FIG. 3C. FIG. 5C shows a schematic diagram of short-circuiting the first gate signal line, the second gate signal line and the third gate signal line according to still another embodiment based on FIG. 3C. FIG. 5D shows a schematic diagram of short-circuiting the first gate signal line, the second gate signal line and the third gate signal line according to yet another embodiment based on FIG. 3C.

As shown in FIG. 5A and FIG. 5D, the gate signal line includes: the first connection point D1 where the first gate signal line VGHO is connected to the first gate driving unit 11; the second connection point D2 where the second gate signal line VGHE is connected to the second gate driving unit 12; the third connection point D3 where the third gate signal line VGHC is connected to the first gate driving unit 11 or the second gate driving unit 12; and the short-circuit connection point DD away from the first connection point D1, the second connection point D2 and/or the third connection point D3 on the gate signal line, where the short-circuit connection point DD is used to short-circuit the first gate signal line VGHO, the second gate signal line VGHE and the third gate signal line VGHC.

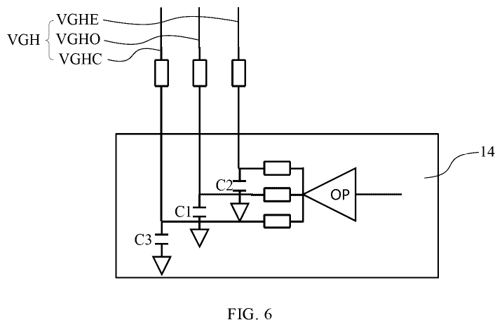

FIG. 6 shows a schematic structural diagram of the voltage stabilizing capacitor according to an embodiment of the present disclosure.

As shown in FIG. 6, the voltage stabilizing capacitor C connected to the first gate signal line VGHO, the second gate signal line VGHE and the third gate signal line VGHC is provided at a position away from the first connection point D1, the second connection point D2 and the third connection point D3 on the gate signal line.

The voltage stabilizing capacitor is provided between the first connection point and the short-circuit connection point, between the second connection point and the short-circuit connection point, and between the third connection point and the short-circuit connection point. The short-circuit connection point is located in the flexible printed circuit 14.

The voltage stabilizing capacitor C includes: a first voltage stabilizing capacitor C1 connected to the first gate signal line VGHO; a second stabilizing capacitor C2 connected to the second gate signal line VGHE; and a third voltage stabilizing capacitor C3 connected to the third gate signal line VGHC. The voltage stabilizing capacitor is provided in the flexible printed circuit of the display substrate.

In other optional embodiments of the present disclosure, the short-circuit connection point DD may also be provided in the driver integrated circuit.

According to the embodiments of the present disclosure, by providing each gate signal line (for example, the first gate signal line, the second gate signal line and the third gate signal line) with the voltage stabilizing capacitor, it is possible to prevent the signal jitter on the gate signal line from affecting signals on other gate signal lines, and thus improve the display effect of the display substrate.

As shown in FIG. 5A, the short-circuit connection point is located at the edge of the display region of the display substrate. As shown in FIG. 5B, the short-circuit connection point is located in the flexible printed circuit of the display substrate. As shown in FIG. 5C and FIG. 5D, the short-circuit connection point is located in the driver integrated circuit of the display substrate.

As shown in FIG. 5C, the first gate signal line VGHO, the second gate signal line VGHE and the third gate signal line VGHC are respectively pulled onto adjacent pins in the driver integrated circuit 13 and short-circuited in the driver integrated circuit. As shown in FIG. 5D, the first gate signal line VGHO, the second gate signal line VGHE and the third gate signal line VGHC are respectively pulled onto different pins on the two sides of the driver integrated circuit 13 and short-circuited in the driver integrated circuit.

In some embodiments of the present disclosure, at least two first gate signal lines and at least two second gate signal lines are provided.

For example, two first gate signal lines and two second gate signal lines are provided.

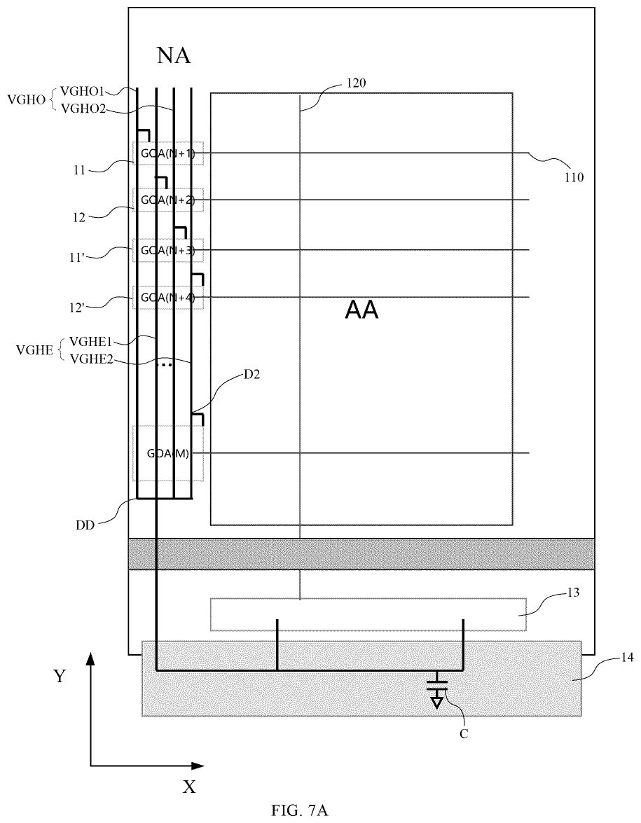

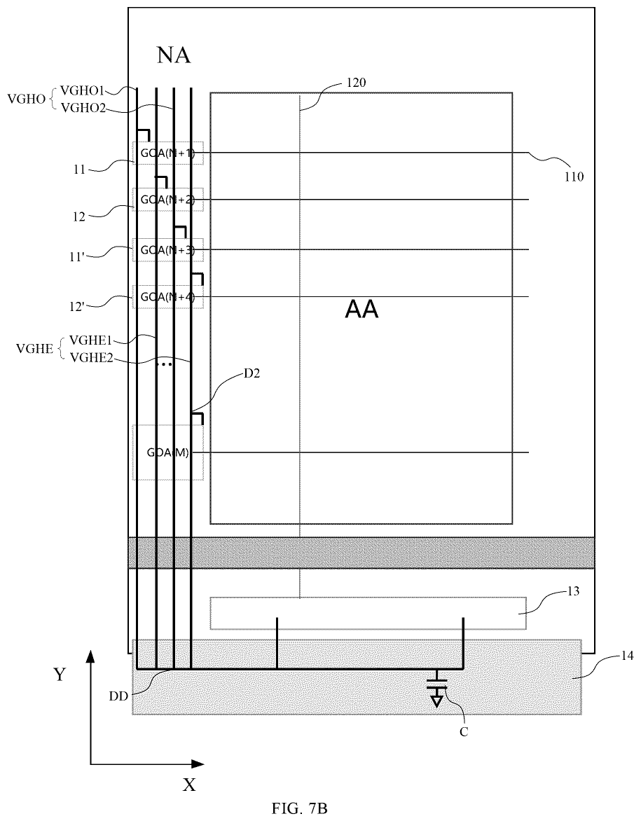

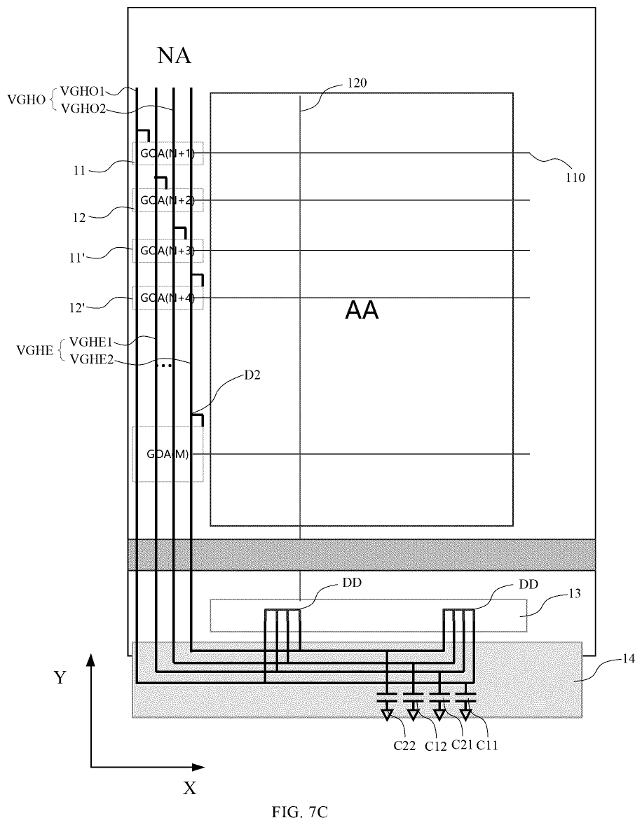

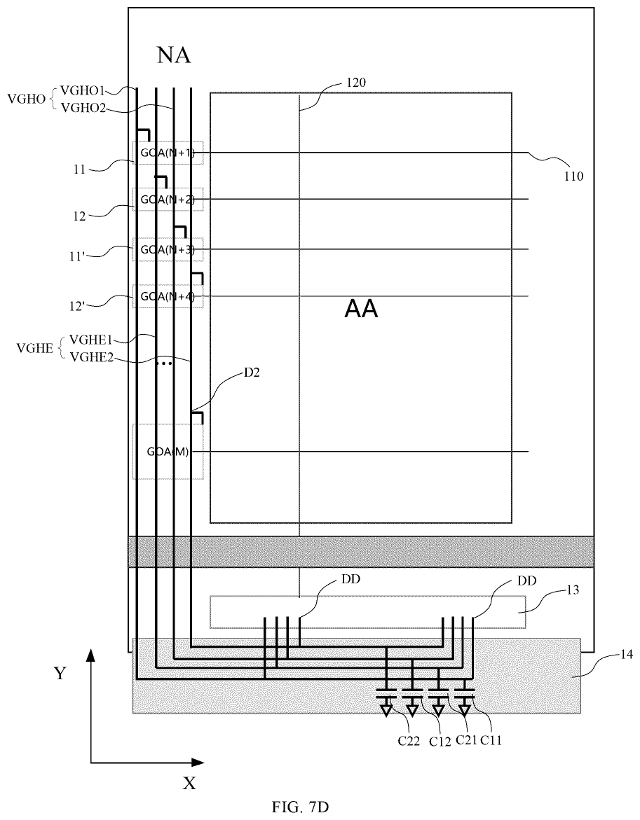

FIG. 7A shows a schematic diagram of short-circuiting a plurality of first gate signal lines and a plurality of second gate signal lines according to an embodiment of the present disclosure. FIG. 7B shows a schematic diagram of short-circuiting a plurality of first gate signal lines and a plurality of second gate signal lines according to another embodiment of the present disclosure. FIG. 7C shows a schematic diagram of short-circuiting a plurality of first gate signal lines and a plurality of second gate signal lines according to still another embodiment of the present disclosure. FIG. 7D shows a schematic diagram of short-circuiting a plurality of first gate signal lines and a plurality of second gate signal lines according to yet another embodiment of the present disclosure.

As shown in FIG. 7A to FIG. 7D, two first gate signal lines VGHO are provided, namely VGHO1 and VGHO2. VGHO1 is connected to the second electrode of the first transistor of the buffer unit in the first gate driving unit 11 for a first row, so that the first gate driving unit for the first row may provide the gate control signal to a pixel group in the first row. VGHO2 is connected to the second electrode of the first transistor of the buffer unit in a first gate driving unit 11′ for a third row, so that the first gate driving unit for the third row may provide the gate control signal to a pixel group in the third row.

Also, two second gate signal lines VHGE are provided, namely VGHE1 and VGHE2. VGHE1 is connected to the second electrode of the first transistor of the buffer unit in the second gate driving unit 12 for a second row, so that the second gate driving unit for the second row may provide the gate control signal to a pixel group in the second row. VGHE2 is connected to the second electrode of the first transistor of the buffer unit in a second gate driving unit 12′ for a fourth row, so that the second gate driving unit for the fourth row may provide the gate control signal to a pixel group in the fourth row.

The connection of other pixel groups in odd-numbered rows and other pixel groups in even-numbered rows with the first gate signal line and the second gate signal line is similar to the above and will not be repeated here.

According to the embodiments of the present disclosure, when two or more first gate signal lines and second gate signal lines are provided, it is possible to effectively avoid the signal fluctuation influence caused by loads on the gate signals, and improve the display effect of the display substrate.

In some embodiments of the present disclosure, the output electrode of the buffer unit includes a first output electrode, a second output electrode, and a third output electrode. The first output electrode is connected to the N-type gate electrode to provide a first gate signal to the N-type gate electrode. The second output electrode is connected to the first P-type gate electrode to provide a second gate signal to the first P-type gate electrode. The third output electrode is connected to the second P-type gate electrode to provide a third gate signal to the second P-type gate electrode.

In some embodiments of the present disclosure, a timing sequence where a maximum pull-down potential generated by a load on the first gate signal line is located does not overlap with a timing sequence where a maximum pull-down potential generated by a load on the second gate signal line is located, when the first gate signal line provides the gate control signal to the pixel group in odd-numbered rows and when the second gate signal line provides the gate control signal to the pixel group in even-numbered rows. A timing sequence where a low voltage signal of the second gate signal is located and a timing sequence where a low voltage signal of the third gate signal is located do not overlap with the timing sequence where the maximum pull-down potential generated by the load on the first gate signal line is located and the timing sequence where the maximum pull-down potential generated by the load on the second gate signal line is located.

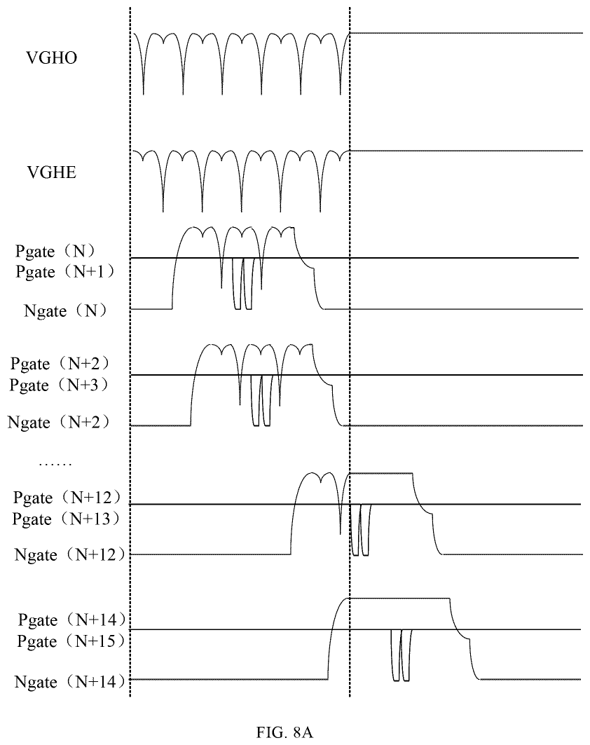

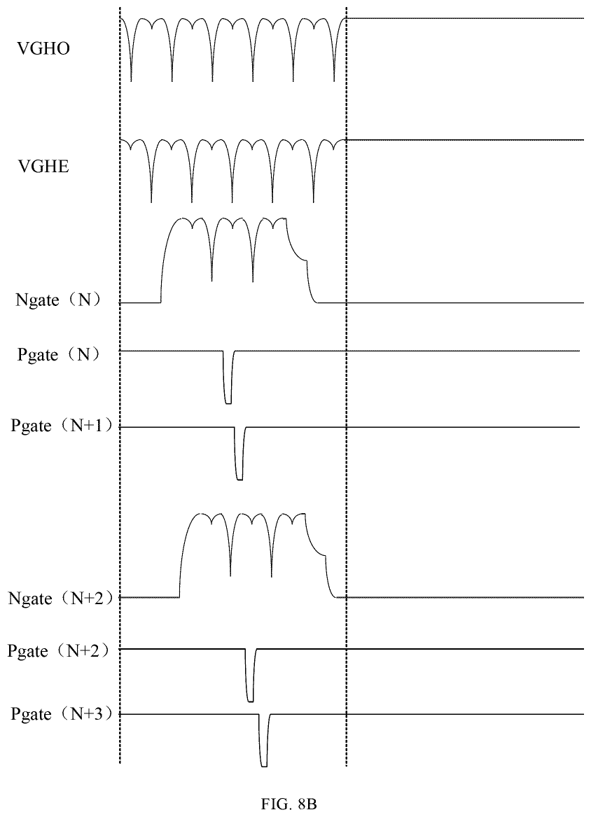

FIG. 8A shows a signal waveform diagram of the first gate signal line, the second gate signal line, the N-type gate electrode, the first P-type gate electrode and the second P-type gate electrode of the display substrate according to an embodiment of the present disclosure. FIG. 8B shows a signal waveform diagram of one first gate signal line, one second gate signal line, one N-type gate electrode, one first P-type gate electrode and one second P-type gate electrode according to an embodiment of the present disclosure.

As shown in FIG. 8A and FIG. 8B, when the first gate signal line VGHO charges a gate wire by pull-up, that is, when the first gate signal line VGHO charges the second electrode of the first transistor of the buffer unit 111 in the first gate driving unit 11 and outputs to the N-type gate, the first P-type gate and the second P-type gate in the pixel circuit through the output electrode of the buffer unit 111, the first gate signal line VGHO may be affected by a resistive load due to a large instantaneous current, and a signal on the first gate signal line VGHO may be pulled down, so that a maximum pull-down potential is generated by load. Similarly, a signal on the second gate signal line VGHE may be pulled down, so that a maximum pull-down potential is generated by load. Since the first gate signal line VGHO and the second gate signal line VGHE are respectively connected to gate driving units corresponding to pixel groups in different rows, the maximum pull-down potentials generated thereon by loads do not overlap in terms of timing sequence.

As shown in FIG. 8A and FIG. 8B, the signal provided by the first gate signal line VGHO to the second electrode of the first transistor of the buffer unit in the first gate driving unit is shown as a waveform diagram corresponding to VGHO, the signal output from the first output electrode of the output electrode of the buffer unit in the first gate driving unit is shown as a waveform diagram corresponding to Ngate (N), the signal output from the second output electrode of the output electrode is shown as a waveform diagram corresponding to Pgate (N), and the signal output from the third output electrode of the output electrode is shown as a waveform diagram corresponding to Pgate (N+1).

The signal provided by the second gate signal line VGHE to the second electrode of the first transistor of the buffer unit in the second gate driving unit is shown as a waveform diagram corresponding to VGHE, the signal output from the first output electrode of the output electrode of the buffer unit in the second gate driving unit is shown as a waveform diagram corresponding to Ngate (N+2), the signal output from the second output electrode of the output electrode is shown as a waveform diagram corresponding to Pgate (N+2), and the signal output from the third output electrode of the output electrode is shown as a waveform diagram corresponding to Pgate (N+3).

As shown in FIG. 8A and FIG. 8B, the timing sequence where the maximum pull-down potential generated by load on the first gate signal line VGHO is located and the timing sequence where the maximum pull-down potential generated by load on the second gate signal line VGHE is located do not overlap, that is, the two may be staggered from each other. A large region is formed between the maximum pull-down potential generated by load on the first gate signal line VGHO and the maximum pull-down potential generated by load on the second gate signal VGHE, so that the first gate signal, the second gate signal and the third gate signal output by the output electrodes of the buffer unit do not interfere with each other.

As shown in FIG. 8B, in the pixel group in odd-numbered rows, the timing sequence where a low voltage signal in the second gate signal (the waveform diagram corresponding to Pgate (N)) is located does not overlap with the timing sequence where a low voltage signal in the third gate signal (the waveform diagram corresponding to Pgate (N+1)) is located, and a fluctuation of the first gate signal (the waveform diagram corresponding to Ngate (N)) caused by a fluctuation on the first gate signal line VGHO in the first gate signal Ngate(N) is spaced apart from the second gate signal and the third gate signal, so that an interference may be avoided.

In the pixel group in even-numbered rows, the timing sequence where a low voltage signal in the second gate signal (the waveform diagram corresponding to Pgate (N+2)) is located does not overlap with the timing sequence where a low voltage signal in the third gate signal (the waveform diagram corresponding to Pgate (N+3)) is located. A fluctuation of the first gate signal (the waveform diagram corresponding to Ngate (N+2)) caused by a fluctuation on the second gate signal line VGHE in the first gate signal Ngate (N+2) is spaced apart from the second gate signal and the third gate signal, so that an interference may be avoided.

In some embodiments of the present disclosure, the display substrate further includes a first clock signal line CK, a second clock signal line CB, an initial signal line, and a control signal line, which are respectively connected to the scan unit of the first gate driving unit and the scan unit of the second gate driving unit.

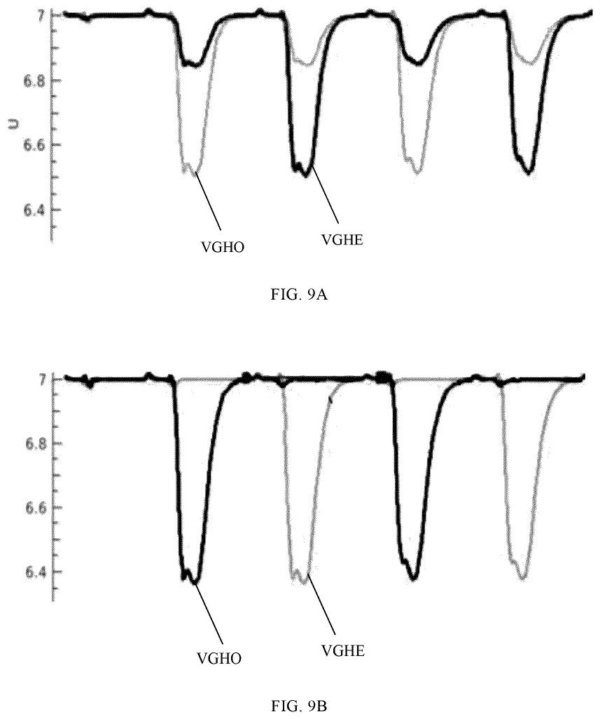

FIG. 9A shows a simulated waveform diagram of the gate control signal on the first signal line and the gate control signal on the second gate signal line in a case that no voltage stabilizing capacitor is provided. FIG. 9B shows a simulated waveform diagram of the gate control signal on the first signal line and the gate control signal on the second gate signal line in a case that the voltage stabilizing capacitor is provided according to an embodiment of the present disclosure

As shown in FIG. 9A, when no voltage stabilizing capacitors are provided for the first gate signal line VGHO and the second gate signal line VGHE before the short-circuit connection point, the voltage waveforms on the two gate signal lines may interfere with each other although they are different, because no voltage stabilizing capacitors are respectively provided before the short-circuit connection point. For example, when the voltage signal on the first gate signal line fluctuates due to load, the voltage signal on the second gate signal line may be affected, resulting in a poor display effect.

As shown in FIG. 9B, by respectively providing voltage stabilizing capacitors C for the first gate signal line VGHO and the second gate signal line VGHE before the short-circuit connection point, such as providing the first voltage stabilizing capacitor C1 on the first gate signal line VGHO and providing the second voltage stabilizing capacitor C2 on the second gate signal line VGHE, no interference may be generated between the first gate signal line VGHO and the second gate signal line VGHE, and the display effect of the display substrate may be effectively improved.

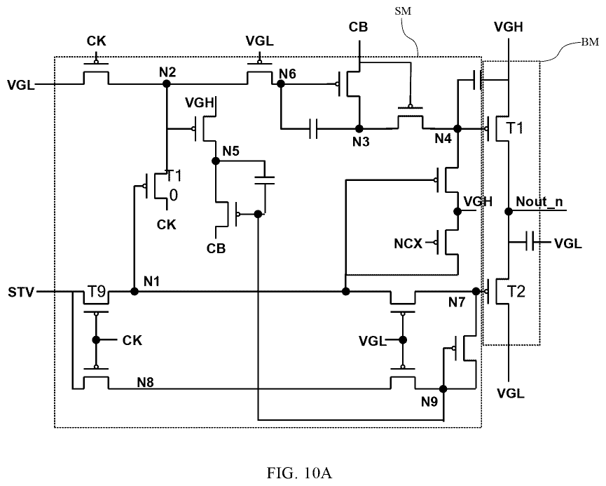

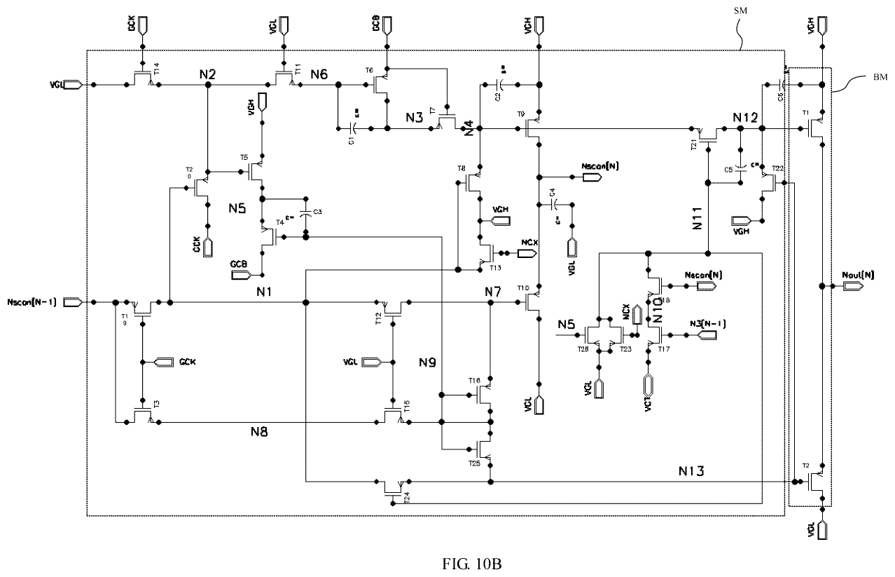

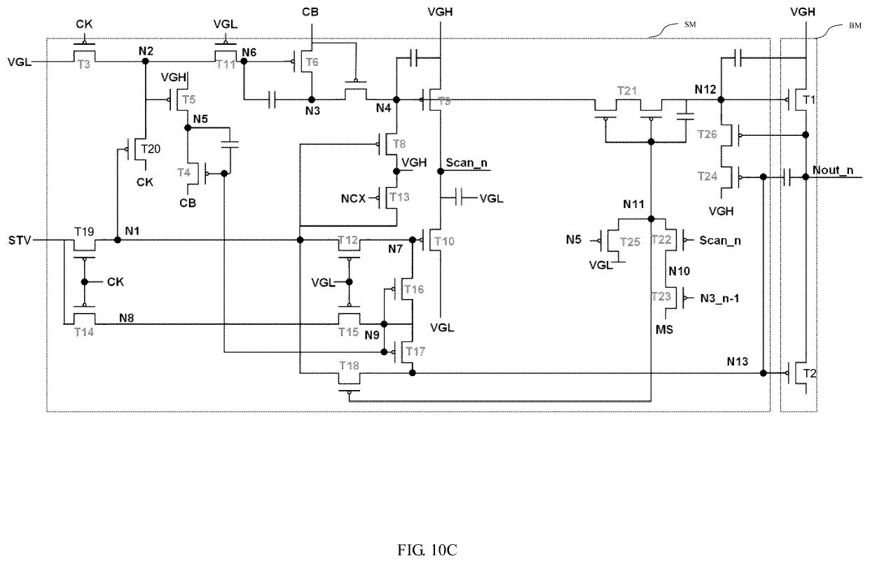

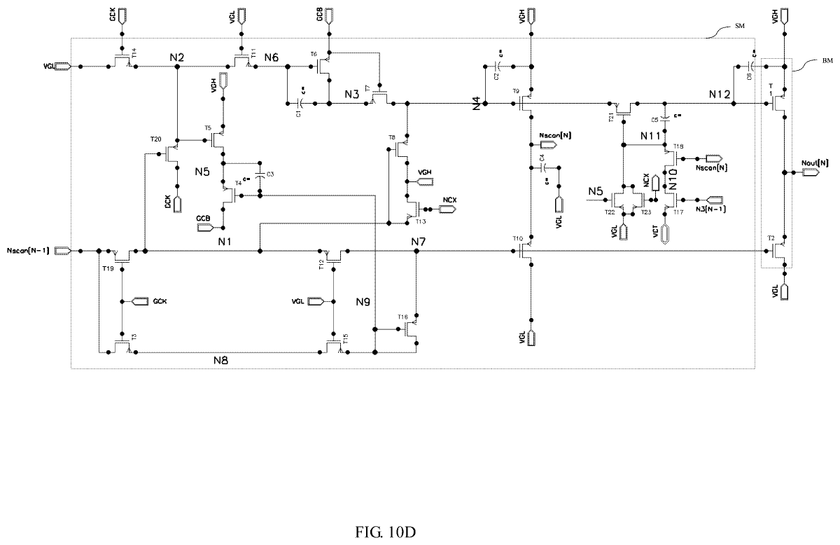

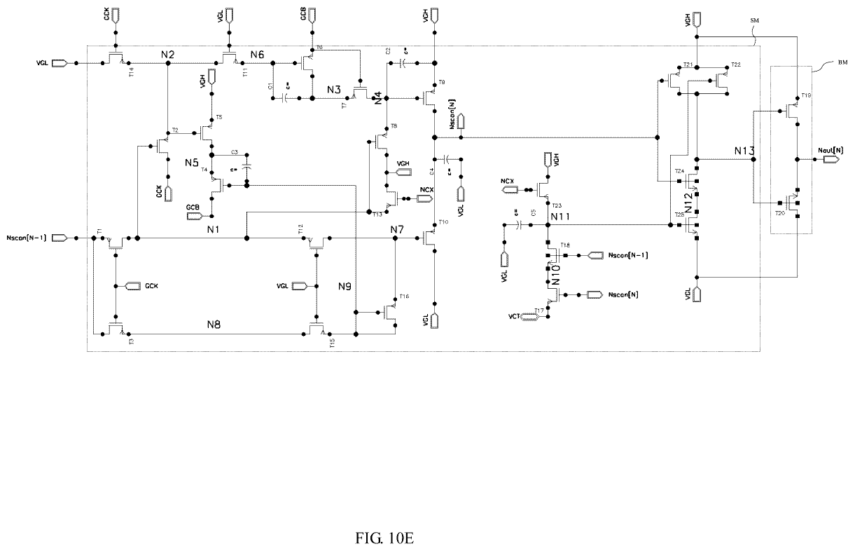

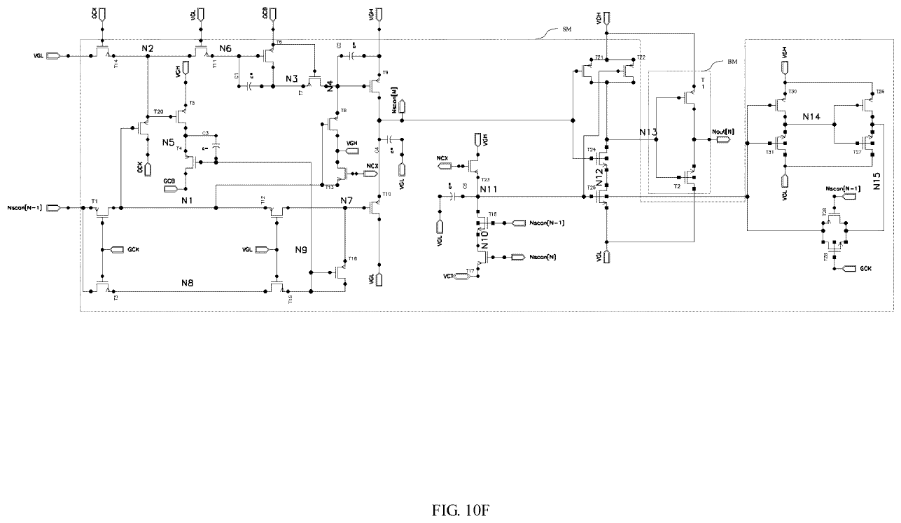

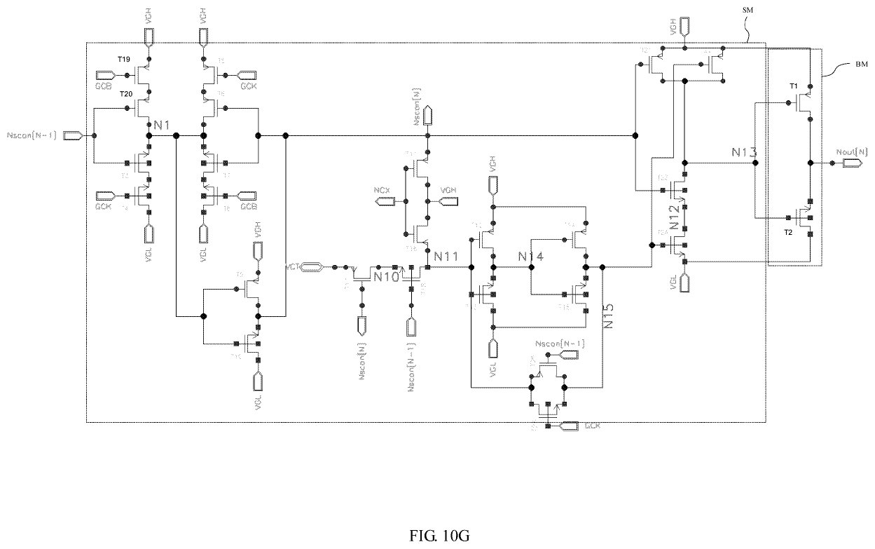

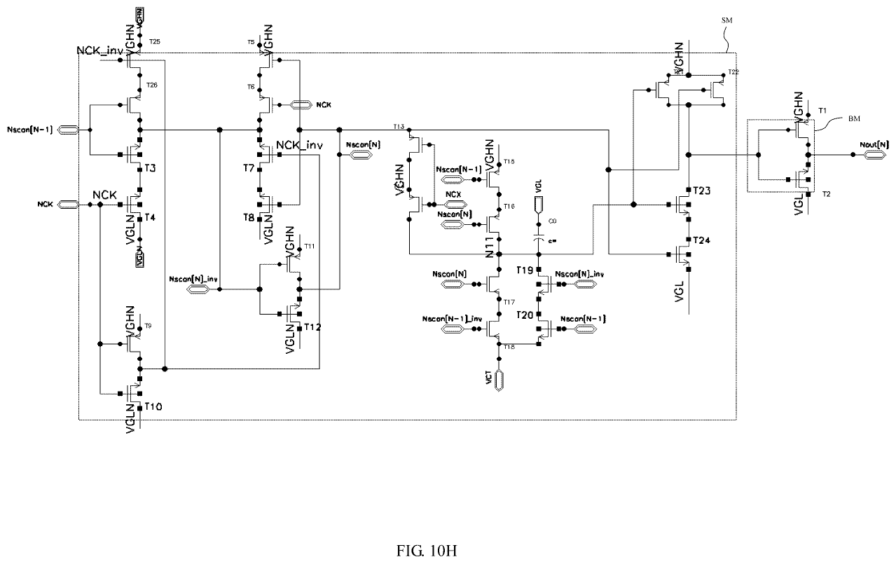

FIG. 10A shows a circuit structure diagram of the first gate driving unit according to an embodiment of the present disclosure. FIG. 10B shows a circuit structure diagram of the first gate driving unit according to an embodiment of the present disclosure. FIG. 10C shows a circuit structure diagram of the first gate driving unit according to an embodiment of the present disclosure. FIG. 10D shows a circuit structure diagram of the first gate driving unit according to an embodiment of the present disclosure. FIG. 10E shows a circuit structure diagram of the first gate driving unit according to an embodiment of the present disclosure. FIG. 10F shows a circuit structure diagram of the first gate driving unit according to an embodiment of the present disclosure. FIG. 10G shows a circuit structure diagram of the first gate driving unit according to an embodiment of the present disclosure. FIG. 10H shows a circuit structure diagram of the first gate driving unit according to an embodiment of the present disclosure.

FIG. 10A to FIG. 10H show circuit diagrams of the first gate driving unit of the display substrate that may be applied to the embodiments of the present disclosure. In the embodiments of the present disclosure, a circuit structure of the first gate driving unit may be completely the same as a circuit structure of the second gate driving unit.

In an embodiment, as shown in FIG. 10A, the circuit structure of the first gate driving unit and the circuit structure of the second gate driving unit are as follows.

The first gate driving unit includes a buffer unit BM and a scan unit SM.

The buffer unit includes a first transistor T1 and a second transistor T2. A gate electrode of the first transistor T1 is connected to a pull-up node N4, and a gate electrode of the second transistor T2 is connected to a pull-down node N7. A first electrode of the first transistor T1 and a first electrode of the second transistor T2 are connected to an output electrode Nout n of the buffer unit. A second electrode of the first transistor T1 is connected to the first gate signal line VGHO, and a second electrode of the second transistor is connected to the reference gate signal line VGL.

A first clock signal line CK, a second clock signal line CB, an initial signal line STV, a reference gate signal line VGL and a control signal line NCX are connected to the scan unit.

In the embodiment shown in FIG. 3A, if the first gate driving unit and the second gate driving unit have the circuit structure shown in FIG. 10A, the scan unit 112 in the first gate driving unit is further connected to the first gate signal line VGHO. For example, an electrode of a fifth transistor T5, an electrode of an eighth transistor T8 and an electrode of a thirteenth transistor T13 in the circuit diagram are connected to the first gate signal line VGHO. The scan unit 122 in the second gate driving unit is further connected to the second gate signal line VGHE. For example, an electrode of the fifth transistor T5, an electrode of the eighth transistor T8 and an electrode of the thirteenth transistor T13 in the circuit diagram are connected to the second gate signal line VGHO.

In the embodiment shown in FIG. 3B, if the first gate driving unit and the second gate driving unit have the circuit structure shown in FIG. 10A, the scan unit 112 in the first gate driving unit is further connected to the second gate signal line VGHE. For example, an electrode of the fifth transistor T5, an electrode of the eighth transistor T8 and an electrode of the thirteenth transistor T13 in the circuit diagram are connected to the second gate signal line VGHE. The scan unit 122 in the second gate driving unit is further connected to the first gate signal line VGHO. For example, an electrode of the fifth transistor T5, an electrode of the eighth transistor T8 and an electrode of the thirteenth transistor T13 in the circuit diagram are connected to the first gate signal line VGHO.

In the embodiment shown in FIG. 3C, if the first gate driving unit and the second gate driving unit have the circuit structure shown in FIG. 10A, the scan unit 112 in the first gate driving unit and the scan unit 122 in the second gate driving unit are both connected to the third gate signal line VGHC. That is, in both the first gate driving unit and the second gate driving unit, for example, an electrode of the fifth transistor T5, an electrode of the eighth transistor T8 and an electrode of the thirteenth transistor T13 in the circuit diagram are connected to the first gate signal line VGHC.

As shown in FIG. 10B to FIG. 10H, the first gate driving unit and the second gate driving unit have the same circuit structure, each including the buffer unit BM and the scan unit SM.

Each of the buffer units BM includes the first transistor T1 and the second transistor T2. The second electrode of the first transistor T1 in the buffer unit BM is connected to a corresponding gate signal line. For example, in a case of the first gate driving unit, the corresponding gate signal line is the first gate signal line, and in a case of the second gate driving unit, the corresponding gate signal line is the second gate signal line. The second electrode of the second transistor is connected to the reference gate signal line.

In the embodiments of the present disclosure, the scan unit SM varies with a circuit design. A connection mode of the gate signal line with the buffer unit BM and the scan unit SM specifically includes three modes as shown in FIG. 3A, FIG. 3B, and FIG. 3C.

As for the scan unit SM in the embodiment of FIG. 3A, the scan unit in the first gate driving unit is connected to the first gate signal line VGHO, and the scan unit in the second gate driving unit is connected to the second gate signal line VGHE.

As for the scan unit SM in the embodiment of FIG. 3B, the scan unit in the first gate driving unit is connected to the second gate signal line VGHE, and the scan unit in the second gate driving unit is connected to the first gate signal line VGHO.

As for the scan unit SM in the embodiment of FIG. 3C, the scan unit in the first gate driving unit and the scan unit in the second gate driving unit are both connected to the third gate signal line VGHC.

According to the embodiments of the present disclosure, by providing the gate signal line as the first gate signal line connected to the first gate driving unit and the second gate signal line connected to the second gate driving unit, the first gate signal line may provide the gate control signal to the pixel group in odd-numbered rows, and the second gate signal line may provide the gate control signal to the pixel group in even-numbered rows, that is, a segmented control of the gate control signal is achieved, so that a problem that the noise is generated by load on the gate signal line which may further affect the pixel circuits to cause an uneven display of two rows of pixel circuits in a pixel group may be effectively avoided, and the display effect of the display substrate may be effectively improved.

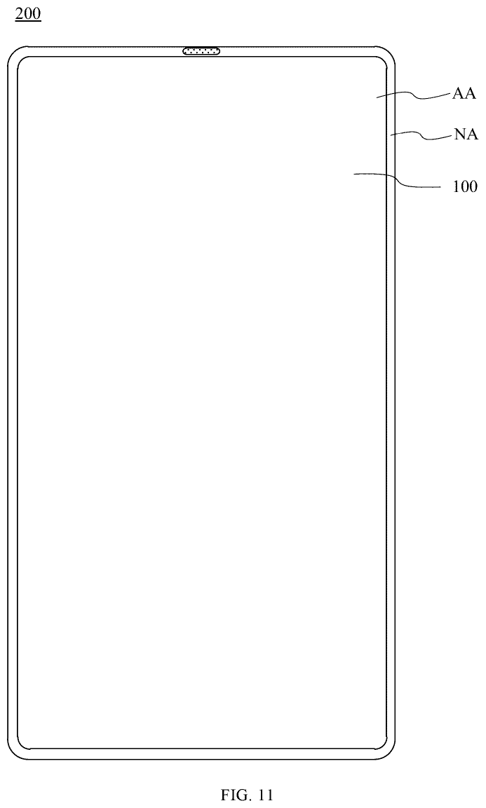

FIG. 11 shows a schematic diagram of a display device according to an embodiment of the present disclosure.

As shown in FIG. 11, at least some embodiments of the present disclosure further provide a display device 200. The display device 200 may include the display substrate 100 as mentioned above. The display device 200 includes a display region AA and a non-display region NA, and the non-display region NA has a small width and a high pixel density, so that a display device with narrow bezel and high PPI may be achieved.

The display device may include any apparatus or product having a display function. For example, the display device may be a smart phone, a mobile phone, an e-book reader, a desktop personal computer (PC), a laptop PC, a netbook PC, a personal digital assistant (PDA), a portable multimedia player (PMP), a digital audio player, a mobile medical apparatus, a camera, a wearable apparatus (such as a head-mounted apparatus, electronic clothing, electronic bracelet, electronic necklace, electronic accessory, electronic tattoo, or smart watch), a television, etc.

It should be understood that the display device according to the embodiments of the present disclosure has all the features and advantages of the above-mentioned display substrate, and details may be referred to the above descriptions, which will not be repeated here.

Herein, the terms “substantially”, “about”, “approximately”, “roughly” and other similar terms are used as terms of approximation rather than terms of degree, and they are intended to explain an inherent deviation of a measured or calculated value that will be recognized by those ordinary skilled in the art. Taking into account a process fluctuation, a measurement problem, an error related to a measurement of a specific quantity (that is, a limitation of a measurement system) and other factors, the terms “about” or “approximately” used here includes a stated value and means that a specific value determined by those ordinary skilled in the art is within an acceptable range of deviation. For example, “about” may mean being within one or more standard deviations, or within ±30%, ±20%, ±10% or ±5% of the stated value.

Some embodiments of the general technical concept of the present disclosure have been shown and described. However, those ordinary skilled in the art may understand that changes may be made to these embodiments without departing from the principle and spirit of the general technical concept, and the scope of the present disclosure is defined by the claims and their equivalents.

1. A display substrate, comprising:
a gate signal line, comprising a first gate signal line and a second gate signal line spaced apart from each other, wherein each of the first gate signal line and the second gate signal line is applied with a first voltage;
a first gate driving unit a second gate driving unit comprising a buffer unit, wherein each of the first driving unit and the second driving unit comprises a buffer unit, the buffer unit comprises a first transistor, a second transistor, and an output electrode configured to output a gate control signal, a first electrode of the first transistor and a first electrode of the second transistor are connected to the output electrode, and a second electrode of the first transistor is connected to the gate signal line; and
pixel circuits electrically connected to the output electrode of the buffer unit, wherein the pixel circuits comprise a pixel group in odd-numbered rows and a pixel group in even-numbered rows, and the pixel group comprises at least two rows of pixel circuits,
wherein the first gate signal line is connected to the second electrode of the first transistor of the first gate driving unit so that the first gate driving unit provides the gate control signal to the pixel group in odd-numbered rows, and the second gate signal line is connected to the second electrode of the first transistor of the second gate driving unit so that the second gate driving unit provides the gate control signal to the pixel group in even-numbered rows.

2. The display substrate according to claim 1, further comprising:
a reference gate signal line applied with a second voltage, wherein the reference gate signal line is connected to a second electrode of the second transistor of the buffer unit.

3. The display substrate according to claim 2, wherein each of the first gate driving unit and the second gate driving unit further comprises a scan unit connected to the gate signal line.

4. The display substrate according to claim 3, wherein the scan unit in the first gate driving unit is electrically connected to the first gate signal line, and the scan unit in the second gate driving unit is electrically connected to the second gate signal line.

5. The display substrate according to claim 3, wherein the scan unit in the first gate driving unit is electrically connected to the second gate signal line, and the scan unit in the second gate driving unit is electrically connected to the first gate signal line.

6. The display substrate according to claim 3, wherein,
the gate signal line further comprises a third gate signal line applied with the first voltage, and the third gate signal line is spaced apart from the first gate signal line and the second gate signal line;
the third gate signal line is connected to the scan unit in the first gate driving unit; and
the third gate signal line is connected to the scan unit in the second gate driving unit.

7. The display substrate according to claim 4, wherein,
the reference gate signal line is connected to the scan unit in the first gate driving unit; and
the reference gate signal line is connected to the scan unit in the second gate driving unit.

8. The display substrate according to claim 6, wherein the gate signal line comprises:
a first connection point where the first gate signal line is connected to the first gate driving unit;
a second connection point where the second gate signal line is connected to the second gate driving unit; and/or
a third connection point where the third gate signal line is connected to the first gate driving unit or the second gate driving unit; and
a short-circuit connection point away from the first connection point, the second connection point and/or the third connection point on the gate signal line, wherein the short-circuit connection point is configured to short-circuit the first gate signal line, the second gate signal line and/or the third gate signal line.

9. The display substrate according to claim 8, wherein a voltage stabilizing capacitor is provided at a position away from the first connection point, the second connection point and/or the third connection point on the gate signal line, and the voltage stabilizing capacitor is connected to the first gate signal line, the second gate signal line and/or the third gate signal line.

10. The display substrate according to claim 9, wherein the voltage stabilizing capacitor is provided between the first connection point and the short-circuit connection point, between the second connection point and the short-circuit connection point, and/or between the third connection point and the short-circuit connection point.

11. The display substrate according to claim 10, wherein the voltage stabilizing capacitor comprises:
a first voltage stabilizing capacitor connected to the first gate signal line;
a second voltage stabilizing capacitor connected to the second gate signal line; and/or
a third voltage stabilizing capacitor connected to the third gate signal line.

12. The display substrate according to claim 11, wherein,
the short-circuit connection point is located at an edge of a display region of the display substrate; or
the short-circuit connection point is located in a flexible printed circuit in the display substrate; or
the short-circuit connection point is located in a driver integrated circuit in the display substrate.

13. The display substrate according to claim 12, wherein the voltage stabilizing capacitor is provided in the flexible printed circuit in the display substrate.

14. The display substrate according to claim 1, wherein the display substrate comprises at least two first gate signal lines and at least two second gate signal lines.

15. The display substrate according to claim 1, wherein,
each pixel group in the pixel circuits comprises a first row of pixel circuits and a second row of pixel circuits arranged in parallel with the first row of pixel circuits;
the first row of pixel circuits and the second row of pixel circuits comprise a common N-type gate electrode; and
the first row of pixel circuits comprises a first P-type gate electrode, and the second row of pixel circuits comprises a second P-type gate electrode.

16. The display substrate according to claim 15, wherein the output electrode comprises:
a first output electrode connected to the N-type gate electrode so as to provide a first gate signal to the N-type gate electrode;
a second output electrode connected to the first P-type gate electrode so as to provide a second gate signal to the first P-type gate electrode; and
a third output electrode connected to the second P-type gate electrode so as to provide a third gate signal to the second P-type gate electrode.

17. The display substrate according to claim 16, wherein a low voltage signal in the second gate signal does not overlap with a low voltage signal in the third gate signal in terms of timing sequence.

18. The display substrate according to claim 3, further comprising:
a first clock signal line, a second clock signal line, an initial signal line, and a control signal line connected to the scan unit.

19. The display substrate according to claim 16, wherein,
a timing sequence where a maximum pull-down potential generated by load on the first gate signal line is located does not overlap with a timing sequence where a maximum pull-down potential generated by load on the second gate signal line is located, when the first gate signal line provides the gate control signal to the pixel group in odd-numbered rows and when the second gate signal line provides the gate control signal to the pixel group in even-numbered rows; and
a timing sequence where the low voltage signal of the second gate signal is located and a timing sequence where the low voltage signal of the third gate signal is located do not overlap with the timing sequence where the maximum pull-down potential generated by load on the first gate signal line is located and the timing sequence where the maximum pull-down potential generated by load on the second gate signal line is located.

20. A display device, comprising the display substrate of claim 1.
